(19) United States
(12) Patent Application Publication
(10) Pub. No.: US 2011/0232825 A1
(43) Pub. Date: Sep. 29, 2011

(54) CYCLOHEXANE POLYCARBOXYLIC ACID DERIVATIVES AS PLASTICIZERS FOR ADHESIVES AND SEALANTS

(75) Inventors: Helmut Mack, Traunstein (DE); Tobias Austermann, Muenster (DE); Boris Breitscheidel, Limburgerhof (DE); Jochen Wagner, Ruppertsweiler (DE)

(73) Assignee: BASF SE, Ludwigshafen (DE)

(21) Appl. No.: 13/132,888

(22) PCT Filed: Dec. 2, 2009
(86) PCT No.: PCT/EP2009/066184

§ 371 Date: Jun. 3, 2011

(30) Foreign Application Priority Data
Dec. 5, 2008 (EP) 08170809.1

(51) Int. Cl. E04F 13/00; C08K 5/12; C09J 175/04; C09J 171/00

(52) U.S. Cl. 156/71; 524/285; 523/122

(57) ABSTRACT

The invention provides an adhesive or sealant comprising at least (A) one compound selected from the group consisting of silylated polyurethanes, silylated polyureas, silylated polyethers, silylated polysulfides and silyl-terminated acrylates, and at least (B) one cyclohexane polycarboxylic acid derivative. The composition has enhanced extensibility with good adhesion properties and high tensile strength. A process is disclosed for preparing the adhesive or sealant, and also disclosed is the use thereof for producing material bonds between parts to be joined.

The present invention relates to adhesives and sealants based on silylated polymers comprising cyclohexanepolycarboxylic acid derivatives, to a process for preparing them, and to their use.

Adhesives and sealants based on silylated polyurethanes, e.g. Bayer Desmoseal®; silylated polyureas; silyl-terminated polyethers, e.g. Kaneka MS Polymer®; a,ω-silyl-terminated acrylates, or acrylate telechelics, e.g. Kaneka X-MAP®, and silylated polysulfides, e.g. Toray Silyl LP, have a very broad applications spectrum and are used, in formulations adapted to the particular end use, in—for example—construction and civil engineering, in the aircraft or automotive industry, and in watercraft construction. A key component of such a formulation is generally plasticizers, which may account for a fraction of more than 40% of the total formulation. Plasticizers, according to DIN 55945, are inert organic solids and liquids which have a low vapor pressure. Through their solvency and their swelling capacity, they reduce the hardness of the polymer, compatibilize the filler/polymer mixture, and raise the low-temperature elasticity. Plasticizers in adhesives and sealants also serve in particular to increase the extensibility of the film that is produced.

It is known that the structure of the alkoxysilanes which are attached to the polymer for further crosslinking has a direct influence on the mechanical properties of the polymer, such as cure rate, extensibility, tensile strength, and flexibility, for instance. Typical examples of the influence of the structure of the terminal silane groups on polyurethanes on the properties of the cured polymer are described in U.S. Pat. No. 4,374,237.

U.S. Pat. No. 6,310,170 discloses compositions comprising silylated polymers, more particularly silylated polyurethanes and silylated polyethers also. Added to the composition as adhesion promoters are specific silanes, for the purpose of increasing the adhesiveness and extensibility of the system, this being of great advantage in the sector of adhesives and sealants in particular. The compositions further comprise plasticizers, with diisononyl phthalate and diisodecyl phthalate being mentioned explicitly, in particular. A disadvantage here, however, is that further, relatively expensive, specific silanes have to be added to the compositions in order to improve the mechanical properties of the silylated polymers.

Because the stated compounds and methods have still not ultimately solved, and especially not from an economic standpoint, the fundamental problem of the optimization of the mechanical properties of silylated polymers, the object of the present invention is that of developing further, cost-effective formulations on the basis of silylated polymers that exhibit improved mechanical properties, more particularly an enhanced extensibility in conjunction with high reactivity and good adhesion properties.

This object has been achieved in accordance with the invention by means of adhesives or sealants comprising at least (A) one compound selected from the group consisting of silylated polyurethanes, silylated polyureas, silylated polyethers, silylated polysulfides and silyl-terminated acrylates, and at least (B) one cyclohexanepolycarboxylic acid derivative. Surprisingly it has been found that this composition, in comparison to the prior art, has an enhanced extensibility, without a detrimental effect on the other performance properties.

The present invention accordingly provides an adhesive or sealant based on silylated polymers comprising at least one cyclohexanecarboxylic acid derivative, a process for preparing these adhesives and sealants, and also their use.

The adhesive or sealant preferably comprises cyclohexanepolycarboxylic acid derivatives of the formula (I)

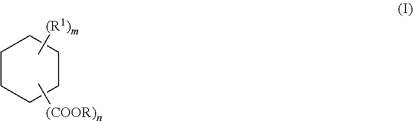

in which

R¹ represents C₁-C₁₀-alkyl or C₃-C₈-cycloalkyl,

m represents 0, 1, 2 or 3,

n represents 2, 3 or 4 and

R represents hydrogen or C₁-C₃₀-alkyl, C₁-C₃₀-alkoxy or C₃-C₈-cycloalkyl, at least one radical R representing C₁-C₃₀-alkyl, C₁-C₃₀-alkoxy or C₃-C₈-cycloalkyl.

In the formula (I), the radicals R¹ may be identical or different if m is 2 or 3. The C₁-C₁₀-alkyl groups may be straight-chain or branched. If R¹ represents an alkyl group, it is preferably a C₁-C₈-alkyl group, particularly preferably a C₁-C₆-alkyl group. Examples of such alkyl groups are methyl, ethyl, n-propyl, isopropyl, n-butyl, isobutyl, sec-butyl, tert-butyl, n-pentyl, n-hexyl, n-octyl and 2-ethylhexyl. Preferably, m is 0.

The m radicals R may be identical or different. The C₁-C₃₀-alkyl groups and the alkyl radicals of the C₁-C₃₀-alkoxy groups may be straight-chain or branched. R is preferably C₁-C₃₀-alkyl, C₁-C₂₀-alkyl, particularly preferably C₁-C₁₈-alkyl, very particularly preferably C₁-C₁₃-alkyl. Examples of such alkyl groups are the alkyl groups already mentioned for R¹, and n-nonyl, isononyl, n-decyl, isodecyl, n-undecyl, isoundecyl, n-dodecyl, isododecyl, n-tridecyl, isotridecyl, stearyl and n-eicosyl.

The alkyl groups may be in each case individual isomers of said alkyl groups or mixtures of different alkyl groups. The different alkyl groups may be different isomers having the same number of carbon atoms and/or alkyl groups which have a different number of carbon atoms.

The cyclohexanepolycarboxylic acid derivatives used according to the invention are in particular mono-, di-, tri- and tetraesters and anhydrides of the cyclohexanepolycarboxylic acids. Preferably, all carboxyl groups are present in esterified form. The esters used are alkyl, cycloalkyl and alkoxyalkyl esters, preferably alkyl esters, preferred alkyl groups R already having been mentioned above.

The at least one cyclohexanepolycarboxylic acid derivative is preferably selected from the group consisting of mono- and dialkyl esters of phthalic acid, isophthalic acid and terephthalic acid, mono-, di- and trialkyl esters of trimellitic acid, trimesic acid and hemimellitic acid, which esters are hydrogenated on the nucleus, or mono-, di-, tri- and tetraalkyl esters of pyromellitic acid, where the alkyl groups R may be linear or branched and have in each case 1 to 30, preferably 1 to 20, particularly preferably 1 to 18, very particularly preferably 1 to 13, carbon atoms, and mixtures of two or more thereof. Suitable alkyl groups R have already been mentioned above.

Particularly preferred are alkylcyclohexane-1,4-dicarboxylates, such as, for example, monomethyl cyclohexane-1,4-dicarboxylate, dimethyl cyclohexane-1,4-dicarboxylate, diethyl cyclohexane-1,4-dicarboxylate, di-n-propyl cyclohexane-1,4-dicarboxylate, di-n-butyl cyclohexane-1,4-dicarboxylate, di-tert-butyl cyclohexane-1,4-dicarboxylate, diisobutyl cyclohexane-1,4-dicarboxylate, monoglycol cyclohexane-1,4-dicarboxylate, diglycol cyclohexane-1,4-dicarboxylate, di-n-octyl cyclohexane-1,4-dicarboxylate, diisooctyl cyclohexane-1,4-dicarboxylate, mono-2-ethylhexyl cyclohexane-1,4-dicarboxylate, di-2-ethylhexyl cyclohexane-1,4-dicarboxylate, di-n-nonyl cyclohexane-1,4-dicarboxylate, diisononyl cyclohexane-1,4-dicarboxylate, di-n-decyl cyclohexane-1,4-dicarboxylate, di-n-undecyl cyclohexane-1,4-dicarboxylate, diisodecyl cyclohexane-1,4-dicarboxylate, diisododecyl cyclohexane-1,4-dicarboxylate, di-n-octadecyl cyclohexane-1,4-dicarboxylate, diisooctadecyl cyclohexane-1,4-dicarboxylate, di-n-eicosyl cyclohexane-1,4-dicarboxylate, monocyclohexyl cyclohexane-1,4-dicarboxylate, dicyclohexyl cyclohexane-1,4-dicarboxylate; diisopropyl cyclohexane-1,4-dicarboxylate, di-n-hexyl cyclohexane-1,4-dicarboxylate, diisohexyl cyclohexane-1,4-dicarboxylate, di-n-heptyl cyclohexane-1,4-dicarboxylate, diisoheptyl cyclohexane-1,4-dicarboxylate, di-2-propylheptyl cyclohexane-1,4-dicarboxylate, diisoundecyl cyclohexane-1,4-dicarboxylate, di-n-dodecyl cyclohexane-1,4-dicarboxylate, di-n-tridecyl cyclohexane-1,4-dicarboxylate, diisotridecyl cyclohexane-1,4-dicarboxylate, di-n-pentyl cyclohexane-1,4-dicarboxylate, diisopentyl cyclohexane-1,4-dicarboxylate;

diisopropyl cyclohexane-1,2-dicarboxylate, di-n-hexyl cyclohexane-1,2-dicarboxylate, diisohexyl cyclohexane-1,2-dicarboxylate, di-n-heptyl cyclohexane-1,2-dicarboxylate, diisoheptyl cyclohexane-1,2-dicarboxylate, di-2-propylheptyl cyclohexane-1,2-dicarboxylate, diisoundecyl cyclohexane-1,2-dicarboxylate, di-n-dodecyl cyclohexane-1,2-dicarboxylate, di-n-tridecyl cyclohexane-1,2-dicarboxylate, diisotridecyl cyclohexane-1,2-dicarboxylate, di-n-pentyl cyclohexane-1,2-dicarboxylate, diisopentyl cyclohexane-1,2-dicarboxylate;

alkyl cyclohexane-1,2-dicarboxylates, such as, for example, monomethyl cyclohexane-1,2-dicarboxylate, dimethyl cyclohexane-1,2-dicarboxylate, diethyl cyclohexane-1,2-dicarboxylate, di-n-propyl cyclohexane-1,2-dicarboxylate, di-n-butyl cyclohexane-1,2-dicarboxylate, di-tert-butyl cyclohexane-1,2-dicarboxylate, diisobutyl cyclohexane-1,2-dicarboxylate, monoglycol cyclohexane-1,2-dicarboxylate, diglycol cyclohexane-1,2-dicarboxylate, di-n-octyl cyclohexane-1,2-dicarboxylate, diisooctyl cyclohexane-1,2-dicarboxylate, di-2-ethylhexyl cyclohexane-1,2-dicarboxylate, di-n-nonyl cyclohexane-1,2-dicarboxylate, diisononyl cyclohexane-1,2-dicarboxylate, di-n-decyl cyclohexane-1,2-dicarboxylate, diisodecyl cyclohexane-1,2-dicarboxylate, di-n-undecyl cyclohexane-1,2-dicarboxylate, diisododecyl cyclohexane-1,2-dicarboxylate, di-n-octadecyl cyclohexane-1,2-dicarboxylate, diisoctadecyl cyclohexane-1,2-dicarboxylate, di-n-eicosyl cyclohexane-1,2-dicarboxylate, monocyclohexyl cyclohexane-1,2-dicarboxylate, dicyclohexyl cyclohexane-1,2-dicarboxylate;

mixed esters of cyclohexane-1,2-dicarboxylic acid with C₁ to C₁₃-alcohols, such as, for example, ethyl methyl cyclohexane-1,2-dicarboxylate, n-propyl methyl cyclohexane-1,2-dicarboxylate, isopropyl methyl cyclohexane-1,2-dicarboxylate, n-butyl methyl cyclohexane-1,2-dicarboxylate, tert-butyl methyl cyclohexane-1,2-dicarboxylate, isobutyl methyl cyclohexane-1,2-dicarboxylate, glycol methyl cyclohexane-1,2-dicarboxylate, n-hexyl methyl cyclohexane-1,2-dicarboxylate, isohexyl methyl cyclohexane-1,2-dicarboxylate, n-heptyl methyl cyclohexane-1,2-dicarboxylate, isoheptyl methyl cyclohexane-1,2-dicarboxylate, n-octyl methyl cyclohexane-1,2-dicarboxylate, isooctyl methyl cyclohexane-1,2-dicarboxylate, 2-ethylhexyl methyl cyclohexane-1,2-dicarboxylate, n-nonyl methyl cyclohexane-1,2-dicarboxylate, isononyl methyl cyclohexane-1,2-dicarboxylate, 2-propylheptyl methyl cyclohexane-1,2-dicarboxylate, n-decyl methyl cyclohexane-1,2-dicarboxylate, isodecyl methyl cyclohexane-1,2-dicarboxylate, n-undecyl methyl cyclohexane-1,2-dicarboxylate, isoundecyl methyl cyclohexane-1,2-dicarboxylate, n-dodecyl methyl cyclohexane-1,2-dicarboxylate, isododecyl methyl cyclohexane-1,2-dicarboxylate, n-tridecyl methyl cyclohexane-1,2-dicarboxylate, isotridecyl methyl cyclohexane-1,2-dicarboxylate, n-propyl ethyl cyclohexane-1,2-dicarboxylate, isopropyl ethyl cyclohexane-1,2-dicarboxylate, n-butyl ethyl cyclohexane-1,2-dicarboxylate, tert-butyl ethyl cyclohexane-1,2-dicarboxylate, isobutyl ethyl cyclohexane-1,2-dicarboxylate, glycol ethyl cyclohexane-1,2-dicarboxylate, n-hexyl ethyl cyclohexane-1,2-dicarboxylate, isohexyl ethyl cyclohexane-1,2-dicarboxylate, n-heptyl ethyl cyclohexane-1,2-dicarboxylate, isoheptyl ethyl cyclohexane-1,2-dicarboxylate, n-octyl ethyl cyclohexane-1,2-dicarboxylate, isooctyl ethyl cyclohexane-1,2-dicarboxylate, 2-ethylhexyl ethyl cyclohexane-1,2-dicarboxylate, n-nonyl ethyl cyclohexane-1,2-dicarboxylate, isononyl ethyl cyclohexane-1,2-dicarboxylate, 2-propylheptyl ethyl cyclohexane-1,2-dicarboxylate, n-decyl ethyl cyclohexane-1,2-dicarboxylate, isodecyl ethyl cyclohexane-1,2-dicarboxylate, n-undecyl ethyl cyclohexane-1,2-dicarboxylate, isoundecyl ethyl cyclohexane-1,2-dicarboxylate, n-dodecyl ethyl cyclohexane-1,2-dicarboxylate, isododecyl ethyl cyclohexane-1,2-dicarboxylate, n-tridecyl ethyl cyclohexane-1,2-dicarboxylate, isotridecyl ethyl cyclohexane-1,2-dicarboxylate, isopropyl n-propyl cyclohexane-1,2-dicarboxylate, n-butyl n-propyl cyclohexane-1,2-dicarboxylate, tert-butyl n-propyl cyclohexane-1,2-dicarboxylate, isobutyl n-propyl cyclohexane-1,2-dicarboxylate, glycol n-propyl cyclohexane-1,2-dicarboxylate, n-hexyl n-propyl cyclohexane-1,2-dicarboxylate, isohexyl n-propyl cyclohexane-1,2-dicarboxylate, n-heptyl n-propyl cyclohexane-1,2-dicarboxylate, isoheptyl n-propyl cyclohexane-1,2-dicarboxylate, n-octyl n-propyl cyclohexane-1,2-dicarboxylate, isooctyl n-propyl 2-dicarboxylate, 2-ethylhexyl n-propyl cyclohexane-1,2-dicarboxylate, n-nonyl n-propyl cyclohexane-1,2-dicarboxylate, isononyl n-propyl cyclohexane-1,2-dicarboxylate, 2-propylheptyl n-propyl cyclohexane-1,2-dicarboxylate, n-decyl n-propyl cyclohexane-1,2-dicarboxylate, isodecyl n-propyl cyclohexane-1,2-dicarboxylate, n-undecyl n-propyl cyclohexane-1,2-dicarboxylate, isoundecyl n-propyl cyclohexane-1,2-dicarboxylate, n-dodecyl n-propyl cyclohexane-1,2-dicarboxylate, isododecyl n-propyl cyclohexane-1,2-dicarboxylate, n-tridecyl n-propyl cyclohexane-1,2-dicarboxylate, isotridecyl n-propyl cyclohexane-1,2-dicarboxylate, n-butyl isopropyl cyclohexane-1,2-dicarboxylate, tert-butyl isopropyl cyclohexane-1,2-dicarboxylate, isobutyl isopropyl cyclohexane-1,2-dicarboxylate, glycol isopropyl cyclohexane-1,2-dicarboxylate, n-hexyl isopropyl cyclohexane-1,2-dicarboxylate, isohexyl isopropyl cyclohexane-1,2-dicarboxylate, n-heptyl isopropyl cyclohexane-1,2-dicarboxylate, isoheptyl isopropyl cyclohexane-1,2-dicarboxylate, n-octyl isopropyl cyclohexane-1,2-dicarboxylate, isooctyl isopropyl cyclohexane-1,2-dicarboxylate, 2-ethylhexyl isopropyl cyclohexane-1,2-dicarboxylate, n-nonyl isopropyl cyclohexane-1,2-dicarboxylate, isononyl isopropyl cyclohexane-1,2-dicarboxylate, 2-propylheptyl isopropyl cyclohexane-1,2-dicarboxylate, n-decyl isopropyl cyclohexane-1,2-dicarboxylate, isodecyl isopropyl cyclohexane-1,2-dicarboxylate, n-undecyl isopropyl cyclohexane-1,2-dicarboxylate, isoundecyl isopropyl cyclohexane-1,2-dicarboxylate, n-dodecyl isopropyl cyclohexane-1,2-dicarboxylate, isododecyl isopropyl cyclohexane-1,2-dicarboxylate, n-tridecyl isopropyl cyclohexane-1,2-dicarboxylate, isotridecyl isopropyl cyclohexane-1,2-dicarboxylate, tert-butyl n-butyl cyclohexane-1,2-dicarboxylate, isobutyl n-butyl cyclohexane-1,2-dicarboxylate, glycol n-butyl cyclohexane-1,2-dicarboxylate, n-hexyl n-butyl cyclohexane-1,2-dicarboxylate, isohexyl n-butyl cyclohexane-1,2-dicarboxylate, n-heptyl n-butyl cyclohexane-1,2-dicarboxylate, isohepyl n-butyl cyclohexane-1,2-dicarboxylate, n-octyl n-butyl cyclohexane-1,2-dicarboxylate, isooctyl n-butyl cyclohexane-1,2-dicarboxylate, 2-ethylhexyl n-butyl cyclohexane-1,2-dicarboxylate, n-nonyl n-butyl cyclohexane-1,2-dicarboxylate, isononyl n-butyl cyclohexane-1,2-dicarboxylate, 2-propylheptyl n-butyl cyclohexane-1,2-dicarboxylate, n-decyl n-butyl cyclohexane-1,2-dicarboxylate, isodecyl n-butyl cyclohexane-1,2-dicarboxylate, n-undecyl n-butyl cyclohexane-1,2-dicarboxylate, isoundecyl n-butyl cyclohexane-1,2-dicarboxylate, n-dodecyl n-butyl cyclohexane-1,2-dicarboxylate, isododecyl n-butyl cyclohexane-1,2-dicarboxylate, n-tridecyl n-butyl cyclohexane-1,2-dicarboxylate, isotridecyl n-butyl cyclohexane-1,2-dicarboxylate, isobutyl tert-butyl cyclohexane-1,2-dicarboxylate, glycol tert-butyl cyclohexane-1,2-dicarboxylate, n-hexyl tert-butyl cyclohexane-1,2-dicarboxylate, isohexyl tert-butyl cyclohexane-1,2-dicarboxylate, n-heptyl tert-butyl cyclohexane-1,2-dicarboxylate, isoheptyl tert-butyl cyclohexane-1,2-dicarboxylate, n-octyl tert-butyl cyclohexane-1,2-dicarboxylate, isooctyl tert-butyl cyclohexane-1,2-dicarboxylate, 2-ethylhexyl tert-butyl cyclohexane-1,2-dicarboxylate, n-nonyl tert-butyl cyclohexane-1,2-dicarboxylate, isononyl tert-butyl cyclohexane-1,2-dicarboxylate, 2-propylheptyl tert-butyl cyclohexane-1,2-dicarboxylate, n-decyl tert-butyl cyclohexane-1,2-dicarboxylate, isodecyl tert-butyl cyclohexane-1,2-dicarboxylate, n-undecyl tert-butyl cyclohexane-1,2-dicarboxylate, isoundecyl tert-butyl cyclohexane-1,2-dicarboxylate, n-dodecyl tert-butyl cyclohexane-1,2-dicarboxylate, isododecyl tert-butyl cyclohexane-1,2-dicarboxylate, n-tridecyl tert-butyl cyclohexane-1,2-dicarboxylate, isotridecyl tert-butyl cyclohexane-1,2-dicarboxylate, glycol isobutyl cyclohexane-1,2-dicarboxylate, n-hexyl isobutyl cyclohexane-1,2-dicarboxylate, isohexyl isobutyl cyclohexane-1,2-dicarboxylate, n-heptyl isobutyl cyclohexane-1,2-dicarboxylate, isoheptyl isobutyl cyclohexane-1,2-dicarboxylate, n-octyl isobutyl cyclohexane-1,2-dicarboxylate, isooctyl isobutyl cyclohexane-1,2-dicarboxylate, 2-ethylhexyl isobutyl cyclohexane-1,2-dicarboxylate, n-nonyl isobutyl cyclohexane-1,2-dicarboxylate, isononyl isobutyl cyclohexane-1,2-dicarboxylate, 2-propylheptyl isobutyl cyclohexane-1,2-dicarboxylate, n-decyl isobutyl cyclohexane-1,2-dicarboxylate, isodecyl isobutyl cyclohexane-1,2-dicarboxylate, n-undecyl isobutyl cyclohexane-1,2-dicarboxylate, isoundecyl isobutyl cyclohexane-1,2-dicarboxylate, n-dodecyl isobutyl cyclohexane-1,2-dicarboxylate, isododecyl isobutyl cyclohexane-1,2-dicarboxylate, n-tridecyl isobutyl cyclohexane-1,2-dicarboxylate, isotridecyl isobutyl cyclohexane-1,2-dicarboxylate, n-hexylglycol cyclohexane-1,2-dicarboxylate, isohexylglycol cyclohexane-1,2-dicarboxylate, n-heptylglycol cyclohexane-1,2-dicarboxylate, isoheptylglycol cyclohexane-1,2-dicarboxylate, n-octylglycol cyclohexane-1,2-dicarboxylate, isooctylglycol cyclohexane-1,2-dicarboxylate, 2-ethylhexylglycol cyclohexane-1,2-dicarboxylate, n-nonylglycol cyclohexane-1,2-dicarboxylate, isononylglycol cyclohexane-1,2-dicarboxylate, 2-propylheptylglycol cyclohexane-1,2-dicarboxylate, n-decylglycol cyclohexane-1,2-dicarboxylate, isodecylglycol cyclohexane-1,2-dicarboxylate, n-undecylglycol cyclohexane-1,2-dicarboxylate, isoundecylglycol cyclohexane-1,2-dicarboxylate, n-dodecylglycol cyclohexane-1,2-dicarboxylate, isododecylglycol cyclohexane-1,2-dicarboxylate, n-tridecylglycol cyclohexane-1,2-dicarboxylate, isotridecylglycol cyclohexane-1,2-dicarboxylate, isohexyl n-hexyl cyclohexane-1,2-dicarboxylate, n-heptyl n-hexyl cyclohexane-1,2-dicarboxylate, isoheptyl n-hexyl cyclohexane-1,2-dicarboxylate, n-octyl n-hexyl cyclohexane-1,2-dicarboxylate, isooctyl n-hexyl cyclohexane-1,2-dicarboxylate, 2-ethylhexyl n-hexyl cyclohexane-1,2-dicarboxylate, n-nonyl n-hexyl cyclohexane-1,2-dicarboxylate, isononyl n-hexyl cyclohexane-1,2-dicarboxylate, 2-propylheptyl n-hexyl cyclohexane-1,2-dicarboxylate, n-decyl n-hexyl cyclohexane-1,2-dicarboxylate, isodecyl n-hexyl cyclohexane-1,2-dicarboxylate, n-undecyl n-hexyl cyclohexane-1,2-dicarboxylate, isoundecyl n-hexyl cyclohexane-1,2-dicarboxylate, n-dodecyl n-hexyl cyclohexane-1,2-dicarboxylate, isododecyl n-hexyl cyclohexane-1,2-dicarboxylate, n-tridecyl n-hexyl cyclohexane-1,2-dicarboxylate, isotridecyl n-hexyl cyclohexane-1,2-dicarboxylate, n-heptyl isohexyl cyclohexane-1,2-dicarboxylate, isoheptyl isohexyl cyclohexane-1,2-dicarboxylate, n-octyl isohexyl cyclohexane-1,2-dicarboxylate, isooctyl isohexyl cyclohexane-1,2-dicarboxylate, 2-ethylhexyl isohexyl cyclohexane-1,2-dicarboxylate, n-nonyl isohexyl cyclohexane-1,2-dicarboxylate, isononyl isohexyl cyclohexane-1,2-dicarboxylate, 2-propylheptyl isohexyl cyclohexane-1,2-dicarboxylate, n-decyl isohexyl cyclohexane-1,2-dicarboxylate, isodecyl isohexyl cyclohexane-1,2-dicarboxylate, n-undecyl isohexyl cyclohexane-1,2-dicarboxylate, isoundecyl isohexyl cyclohexane-1,2-dicarboxylate, n-dodecyl isohexyl cyclohexane-1,2-dicarboxylate, isododecyl isohexyl cyclohexane-1,2-dicarboxylate, n-tridecyl isohexyl cyclohexane-1,2-dicarboxylate, isotridecyl isohexyl cyclohexane-1,2-dicarboxylate, isoheptyl n-heptyl cyclohexane-1,2-dicarboxylate, n-octyl n-heptyl cyclohexane-1,2-dicarboxylate, isooctyl n-heptyl cyclohexane-1,2-dicarboxylate, 2-ethylhexyl n-heptyl cyclohexane-1,2-dicarboxylate, n-nonyl n-heptyl cyclohexane-1,2-dicarboxylate, isononyl n-heptyl cyclohexane-1,2-dicarboxylate, 2-propylheptyl n-heptyl cyclohexane-1,2-dicarboxylate, n-decyl h-heptyl cyclohexane-1,2-dicarboxylate, isodecyl n-heptyl cyclohexane-1,2-dicarboxylate, n-undecyl n-heptyl cyclohexane-1,2-dicarboxylate, isoundecyl n-heptyl cyclohexane-1,2-dicarboxylate, n-dodecyl n-heptyl cyclohexane-1,2-dicarboxylate, isododecyl n-heptyl cyclohexane-1,2-dicarboxylate, n-tridecyl n-heptyl cyclohexane-1,2-dicarboxylate, isotridecyl n-heptyl cyclohexane-1,2-dicarboxylate, n-octyl isoheptyl cyclohexane-1,2-dicarboxylate, isooctyl isoheptyl cyclohexane-1,2-dicarboxylate, 2-ethylhexyl isoheptyl cyclohexane-1,2-dicarboxylate, n-nonyl isoheptyl cyclohexane-1,2-dicarboxylate, isononyl isoheptyl cyclohexane-1,2-dicarboxylate, 2-propylheptyl isoheptyl cyclohexane-1,2-dicarboxylate, n-decyl isoheptyl cyclohexane-1,2-dicarboxylate, isodecyl isoheptyl cyclohexane-1,2-dicarboxylate, n-undecyl isoheptyl cyclohexane-1,2-dicarboxylate, isoundecyl isoheptyl cyclohexane-1,2-dicarboxylate, n-dodecyl isoheptyl cyclohexane-1,2-dicarboxylate, isododecyl isoheptyl cyclohexane-1,2-dicarboxylate, n-tridecyl isoheptyl cyclohexane-1,2-dicarboxylate, isotridecyl isoheptyl cyclohexane-1,2-dicarboxylate, isooctyl n-octyl cyclohexane-1,2-dicarboxylate, 2-ethylhexyl n-octyl cyclohexane-1,2-dicarboxylate, n-nonyl n-octyl cyclohexane-1,2-dicarboxylate, isononyl n-octyl cyclohexane-1,2-dicarboxylate, 2-propylheptyl n-octyl cyclohexane-1,2-dicarboxylate, n-decyl n-octyl cyclohexane-1,2-dicarboxylate, isodecyl n-octyl cyclohexane-1,2-dicarboxylate, n-undecyl n-octyl cyclohexane-1,2-dicarboxylate, isoundecyl n-octyl cyclohexane-1,2-dicarboxylate, n-dodecyl n-octyl cyclohexane-1,2-dicarboxylate, isododecyl n-octyl cyclohexane-1,2-dicarboxylate, n-tridecyl n-octyl cyclohexane-1,2-dicarboxylate, isotridecyl n-octyl cyclohexane-1,2-dicarboxylate, 2-ethylhexyl isooctyl cyclohexane-1,2-dicarboxylate, n-nonyl isooctyl cyclohexane-1,2-dicarboxylate, isononyl isooctyl cyclohexane-1,2-dicarboxylate, 2-propylheptyl isooctyl cyclohexane-1,2-dicarboxylate, n-decyl isooctyl cyclohexane-1,2-dicarboxylate, isodecyl isooctyl cyclohexane-1,2-dicarboxylate, n-undecyl isooctyl cyclohexane-1,2-dicarboxylate, isoundecyl isooctyl cyclohexane-1,2-dicarboxylate, n-dodecyl isooctyl cyclohexane-1,2-dicarboxylate, isododecyl, isooctyl cyclohexane-1,2-dicarboxylate, n-tridecyl isooctyl cyclohexane-1,2-dicarboxylate, isotridecyl isooctyl cyclohexane-1,2-dicarboxylate, 2-ethylhexyl n-nonyl cyclohexane-1,2-dicarboxylate, 2-ethylhexyl isononyl cyclohexane-1,2-dicarboxylate, 2-propylheptyl 2-ethylhexyl cyclohexane-1,2-dicarboxylate, n-decyl 2-ethylhexyl cyclohexane-1,2-dicarboxylate, isodecyl 2-ethylhexyl cyclohexane-1,2-dicarboxylate, n-undecyl 2-ethylhexyl cyclohexane-1,2-dicarboxylate, isoundecyl 2-ethylhexyl cyclohexane-1,2-dicarboxylate, n-dodecyl 2-ethylhexyl cyclohexane-1,2-dicarboxylate, isododecyl 2-ethylhexyl cyclohexane-1,2-dicarboxylate, n-tridecyl 2-ethylhexyl cyclohexane-1,2-dicarboxylate, isotridecyl 2-ethylhexyl cyclohexane-1,2-dicarboxylate, isononyl n-nonyl cyclohexane-1,2-dicarboxylate, 2-propylheptyl n-nonyl cyclohexane-1,2-dicarboxylate, n-decyl n-nonyl cyclohexane-1,2-dicarboxylate, isodecyl n-nonyl cyclohexane-1,2-dicarboxylate, n-undecyl n-nonyl cyclohexane-1,2-dicarboxylate, isoundecyl n-nonyl cyclohexane-1,2-dicarboxylate, n-dodecyl n-nonyl cyclohexane-1,2-dicarboxylate, isododecyl n-nonyl cyclohexane-1,2-dicarboxylate, n-tridecyl n-nonyl cyclohexane-1,2-dicarboxylate, isotridecyl n-nonyl cyclohexane-1,2-dicarboxylate, 2-propylheptyl isononyl cyclohexane-1,2-dicarboxylate, n-decyl isononyl cyclohexane-1,2-dicarboxylate, isodecyl isononyl cyclohexane-1,2-dicarboxylate, n-undecyl isononyl cyclohexane-1,2-dicarboxylate, isoundecyl isononyl cyclohexane-1,2-dicarboxylate, n-dodecyl isononyl cyclohexane-1,2-dicarboxylate, isododecyl isononyl cyclohexane-1,2-dicarboxylate, n-tridecyl isononyl cyclohexane-1,2-dicarboxylate, isotridecyl isononyl cyclohexane-1,2-dicarboxylate, n-decyl 2-propylheptyl cyclohexane-1,2-dicarboxylate, isodecyl 2-propylheptyl cyclohexane-1,2-dicarboxylate, n-undecyl 2-propylheptyl cyclohexane-1,2-dicarboxylate, isoundecyl 2-propylheptyl cyclohexane-1,2-dicarboxylate, n-dodecyl 2-propylheptyl cyclohexane-1,2-dicarboxylate, isododecyl 2-propylheptyl cyclohexane-1,2-dicarboxylate, n-tridecyl 2-propylheptyl cyclohexane-1,2-dicarboxylate, isotridecyl 2-propylheptyl cyclohexane-1,2-dicarboxylate, isodecyl n-decyl cyclohexane-1,2-dicarboxylate, n-undecyl n-decyl cyclohexane-1,2-dicarboxylate, isoundecyl n-decyl cyclohexane-1,2-dicarboxylate, n-dodecyl n-decyl cyclohexane-1,2-dicarboxylate, isododecyl n-decyl cyclohexane-1,2-dicarboxylate, n-tridecyl n-decyl cyclohexane-1,2-dicarboxylate, isotridecyl n-decyl cyclohexane-1,2-dicarboxylate, n-undecyl isodecyl cyclohexane-1,2-dicarboxylate, isoundecyl isodecyl cyclohexane-1,2-dicarboxylate, n-dodecyl isodecyl cyclohexane-1,2-dicarboxylate, isododecyl isodecyl cyclohexane-1,2-dicarboxylate, n-tridecyl isodecyl cyclohexane-1,2-dicarboxylate, isotridecyl isodecyl cyclohexane-1,2-dicarboxylate, isoundecyl n-undecyl cyclohexane-1,2-dicarboxylate, n-dodecyl n-undecyl cyclohexane-1,2-dicarboxylate, isododecyl n-undecyl cyclohexane-1,2-dicarboxylate, n-tridecyl n-undecyl cyclohexane-1,2-dicarboxylate, isotridecyl n-undecyl cyclohexane-1,2-dicarboxylate, n-dodecyl isoundecyl cyclohexane-1,2-dicarboxylate, isododecyl isoundecyl cyclohexane-1,2-dicarboxylate, n-tridecyl isoundecyl cyclohexane-1,2-dicarboxylate, isotridecyl isoundecyl cyclohexane-1,2-dicarboxylate, isododecyl n-dodecyl cyclohexane-1,2-dicarboxylate, n-tridecyl n-dodecyl cyclohexane-1,2-dicarboxylate, isotridecyl n-dodecyl cyclohexane-1,2-dicarboxylate, n-tridecyl isododecyl cyclohexane-1,2-dicarboxylate, isotridecyl isododecyl cyclohexane-1,2-dicarboxylate, isotridecyl n-tridecyl cyclohexane-1,2-dicarboxylate, methylcyclohexyl cyclohexane-1,2-dicarboxylate, ethylcyclohexyl cyclohexane-1,2-dicarboxylate, n-propylcyclohexyl cyclohexane-1,2-dicarboxylate, isopropylcyclohexyl cyclohexane-1,2-dicarboxylate, n-butylcyclohexyl cyclohexane-1,2-dicarboxylate, tert-butylcyclohexyl cyclohexane-1,2-dicarboxylate, isobutylcyclohexyl cyclohexane-1,2-dicarboxylate, glycol cyclohexyl cyclohexane-1,2-dicarboxylate, n-hexylcyclohexyl cyclohexane-1,2-dicarboxylate, isohexylcyclohexyl cyclohexane-1,2-dicarboxylate, n-heptylcyclohexyl cyclohexane-1,2-dicarboxylate, isoheptylcyclohexyl cyclohexane-1,2-dicarboxylate, n-octylcyclohexyl cyclohexane-1,2-dicarboxylate, isooctylcyclohexyl cyclohexane-1,2-dicarboxylate, 2-ethylhexyl cyclohexyl cyclohexane-1,2-dicarboxylate, n-nonylcyclohexyl cyclohexane-1,2-dicarboxylate, isononyl cyclohexyl cyclohexane-1,2-dicarboxylate, 2-propylheptyl cyclohexyl cyclohexane-1,2-dicarboxylate, n-decyl cyclohexyl cyclohexane-1,2-dicarboxylate, isodecyl cyclohexyl cyclohexane-1,2-dicarboxylate, n-undecyl cyclohexyl cyclohexane-1,2-dicarboxylate, isoundecyl cyclohexyl cyclohexane-1,2-dicarboxylate, n-dodecyl cyclohexyl cyclohexane-1,2-dicarboxylate, isododecyl cyclohexyl cyclohexane-1,2-dicarboxylate, n-tridecyl cyclohexyl cyclohexane-1,2-dicarboxylate, isotridecyl cyclohexyl cyclohexane-1,2-dicarboxylate, methyl isopentyl cyclohexane-1,2-dicarboxylate, ethyl isopentyl cyclohexane-1,2-dicarboxylate, n-propyl isopentyl cyclohexane-1,2-dicarboxylate, isopropyl isopentyl cyclohexane-1,2-dicarboxylate, n-butyl isopentyl cyclohexane-1,2-dicarboxylate, tert-butyl isopentyl cyclohexane-1,2-dicarboxylate, isobutyl isopentyl cyclohexane-1,2-dicarboxylate, glycol isopentyl cyclohexane-1,2-dicarboxylate, n-hexyl isopentyl cyclohexane-1,2-dicarboxylate, isohexyl isopentyl cyclohexane-1,2-dicarboxylate, n-heptyl isopentyl cyclohexane-1,2-dicarboxylate, isoheptyl isopentyl cyclohexane-1,2-dicarboxylate, n-octyl isopentyl cyclohexane-1,2-dicarboxylate, isooctyl isopentyl cyclohexane-1,2-dicarboxylate, 2-ethylhexyl isopentyl cyclohexane-1,2-dicarboxylate, n-nonyl isopentyl cyclohexane-1,2-dicarboxylate, isononyl isopentyl cyclohexane-1,2-dicarboxylate, 2-propylheptyl isopentyl cyclohexane-1,2-dicarboxylate, n-decyl isopentyl cyclohexane-1,2-dicarboxylate, isodecyl isopentyl cyclohexane-1,2-dicarboxylate, n-undecyl isopentyl cyclohexane-1,2-dicarboxylate, isoundecyl isopentyl cyclohexane-1,2-dicarboxylate, n-dodecyl isopentyl cyclohexane-1,2-dicarboxylate, isododecyl isopentyl cyclohexane-1,2-dicarboxylate, n-tridecyl isopentyl cyclohexane-1,2-dicarboxylate, isotridecyl isopentyl cyclohexane-1,2-dicarboxylate, methyl n-pentyl cyclohexane-1,2-dicarboxylate, ethyl n-pentyl cyclohexane-1,2-dicarboxylate, n-propyl n-pentyl cyclohexane-1,2-dicarboxylate, isopropyl n-pentyl cyclohexane-1,2-dicarboxylate, n-butyl n-pentyl cyclohexane-1,2-dicarboxylate, tert-butyl n-pentyl cyclohexane-1,2-dicarboxylate, isobutyl n-pentyl cyclohexane-1,2-dicarboxylate, glycol n-pentyl cyclohexane-1,2-dicarboxylate, n-hexyl n-pentyl cyclohexane-1,2-dicarboxylate, isohexyl n-pentyl cyclohexane-1,2-dicarboxylate, n-heptyl n-pentyl cyclohexane-1,2-dicarboxylate, isoheptyl n-pentyl cyclohexane-1,2-dicarboxylate, n-octyl n-pentyl cyclohexane-1,2-dicarboxylate, isooctyl n-pentyl cyclohexane-1,2-dicarboxylate, 2-ethylhexyl n-pentyl cyclohexane-1,2-dicarboxylate, n-nonyl n-pentyl cyclohexane-1,2-dicarboxylate, isononyl n-pentyl cyclohexane-1,2-dicarboxylate, 2-propylheptyl n-pentyl cyclohexane-1,2-dicarboxylate, n-decyl n-pentyl cyclohexane-1,2-dicarboxylate, isodecyl n-pentyl cyclohexane-1,2-dicarboxylate, n-undecyl n-pentyl cyclohexane-1,2-dicarboxylate, isoundecyl n-pentyl cyclohexane-1,2-dicarboxylate, n-dodecyl n-pentyl cyclohexane-1,2-dicarboxylate, isododecyl n-pentyl cyclohexane-1,2-dicarboxylate, n-tridecyl n-pentyl cyclohexane-1,2-dicarboxylate, isotridecyl n-pentyl cyclohexane-1,2-dicarboxylate;

mixed esters of cyclohexane-1,3-dicarboxylic acid with C₁- to C₁₃-alcohols, such as, for example, ethyl methyl cyclohexane-1,3-dicarboxylate, n-propyl methyl cyclohexane-1,3-dicarboxylate, isopropyl methyl cyclohexane-1,3-dicarboxylate, n-butyl methyl cyclohexane-1,3-dicarboxylate, tert-butyl methyl cyclohexane-1,3-dicarboxylate, isobutyl methyl cyclohexane-1,3-dicarboxylate, glycol methyl cyclohexane-1,3-dicarboxylate, n-hexyl methyl cyclohexane-1,3-dicarboxylate, isohexyl methyl cyclohexane-1,3-dicarboxylate, n-heptyl methyl cyclohexane-1,3-dicarboxylate, isoheptyl methyl cyclohexane-1,3-dicarboxylate, n-octyl methyl cyclohexane-1,3-dicarboxylate, isooctyl methyl cyclohexane-1,3-dicarboxylate, 2-ethylhexyl methyl cyclohexane-1,3-dicarboxylate, n-nonyl methyl cyclohexane-1,3-dicarboxylate, isononyl methyl cyclohexane-1,3-dicarboxylate, 2-propylheptyl methyl cyclohexane-1,3-dicarboxylate, n-decyl methyl cyclohexane-1,3-dicarboxylate, isodecyl methyl cyclohexane-1,3-dicarboxylate, n-undecyl methyl cyclohexane-1,3-dicarboxylate, isoundecyl methyl cyclohexane-1,3-dicarboxylate, n-dodecyl methyl cyclohexane-1,3-dicarboxylate, isododecyl methyl cyclohexane-1,3-dicarboxylate, n-tridecyl methyl cyclohexane-1,3-dicarboxylate, isotridecyl methyl cyclohexane-1,3-dicarboxylate, n-propyl ethyl cyclohexane-1,3-dicarboxylate, isopropyl ethyl cyclohexane-1,3-dicarboxylate, n-butyl ethyl cyclohexane-1,3-dicarboxylate, tert-butyl ethyl cyclohexane-1,3-dicarboxylate, isobutyl ethyl cyclohexane-1,3-dicarboxylate, glycol ethyl cyclohexane-1,3-dicarboxylate, n-hexyl ethyl cyclohexane-1,3-dicarboxylate, isohexyl ethyl cyclohexane-1,3-dicarboxylate, n-heptyl ethyl cyclohexane-1,3-dicarboxylate, isoheptyl ethyl cyclohexane-1,3-dicarboxylate, n-octyl ethyl cyclohexane-1,3-dicarboxylate, isooctyl ethyl cyclohexane-1,3-dicarboxylate, 2-ethylhexyl ethyl cyclohexane-1,3-dicarboxylate, n-nonyl ethyl cyclohexane-1,3-dicarboxylate, isononyl ethyl cyclohexane-1,3-dicarboxylate, 2-propylheptyl ethyl cyclohexane-1,3-dicarboxylate, n-decyl ethyl cyclohexane-1,3-dicarboxylate, isodecyl ethyl cyclohexane-1,3-dicarboxylate, n-undecyl ethyl cyclohexane-1,3-dicarboxylate, isoundecyl ethyl cyclohexane-1,3-dicarboxylate, n-dodecyl ethyl cyclohexane-1,3-dicarboxylate, isododecyl ethyl cyclohexane-1,3-dicarboxylate, n-tridecyl ethyl cyclohexane-1,3-dicarboxylate, isotridecyl ethyl cyclohexane-1,3-dicarboxylate, isopropyl n-propyl cyclohexane-1,3-dicarboxylate, n-butyl n-propyl cyclohexane-1,3-dicarboxylate, tert-butyl n-propyl cyclohexane-1,3-dicarboxylate, isobutyl n-propyl cyclohexane-1,3-dicarboxylate, glycol n-propyl cyclohexane-1,3-dicarboxylate, n-hexyl n-propyl cyclohexane-1,3-dicarboxylate, isohexyl n-propyl cyclohexane-1,3-dicarboxylate, n-heptyl n-propyl cyclohexane-1,3-dicarboxylate, isoheptyl n-propyl cyclohexane-1,3-dicarboxylate, n-octyl n-propyl cyclohexane-1,3-dicarboxylate, isooctyl n-propyl cyclohexane-1,3-dicarboxylate, 2-ethylhexyl n-propyl cyclohexane-1,3-dicarboxylate, n-nonyl n-propyl cyclohexane-1,3-dicarboxylate, isononyl n-propyl cyclohexane-1,3-dicarboxylate, 2-propylheptyl n-propyl cyclohexane-1,3-dicarboxylate, n-decyl n-propyl cyclohexane-1,3-dicarboxylate, isodecyl n-propyl cyclohexane-1,3-dicarboxylate, n-undecyl n-propyl cyclohexane-1,3-dicarboxylate, isoundecyl n-propyl cyclohexane-1,3-dicarboxylate, n-dodecyl n-propyl cyclohexane-1,3-dicarboxylate, isododecyl n-propyl cyclohexane-1,3-dicarboxylate, n-tridecyl n-propyl cyclohexane-1,3-dicarboxylate, isotridecyl n-propyl cyclohexane-1,3-dicarboxylate, n-butyl isopropyl cyclohexane-1,3-dicarboxylate, tert-butyl isopropyl cyclohexane-1,3-dicarboxylate, isobutyl isopropyl cyclohexane-1,3-dicarboxylate, glycol isopropyl cyclohexane-1,3-dicarboxylate, n-hexyl isopropyl cyclohexane-1,3-dicarboxylate, isohexyl isopropyl cyclohexane-1,3-dicarboxylate, n-heptyl isopropyl cyclohexane-1,3-dicarboxylate, isoheptyl isopropyl cyclohexane-1,3-dicarboxylate, n-octyl isopropyl cyclohexane-1,3-dicarboxylate, isooctyl isopropyl cyclohexane-1,3-dicarboxylate, 2-ethylhexyl isopropyl cyclohexane-1,3-dicarboxylate, n-nonyl isopropyl cyclohexane-1,3-dicarboxylate, isononyl isopropyl cyclohexane-1,3-dicarboxylate, 2-propylheptyl isopropyl cyclohexane-1,3-dicarboxylate, n-decyl isopropyl cyclohexane-1,3-dicarboxylate, isodecyl isopropyl cyclohexane-1,3-dicarboxylate, n-undecyl isopropyl cyclohexane-1,3-dicarboxylate, isoundecyl isopropyl cyclohexane-1,3-dicarboxylate, n-dodecyl isopropyl cyclohexane-1,3-dicarboxylate, isododecyl isopropyl cyclohexane-1,3-dicarboxylate, n-tridecyl isopropyl cyclohexane-1,3-dicarboxylate, isotridecyl isopropyl cyclohexane-1,3-dicarboxylate, tert-butyl n-butyl cyclohexane-1,3-dicarboxylate, isobutyl n-butyl cyclohexane-1,3-dicarboxylate, glycol n-butyl cyclohexane-1,3-dicarboxylate, n-hexyl n-butyl cyclohexane-1,3-dicarboxylate, isohexyl n-butyl cyclohexane-1,3-dicarboxylate, n-heptyl n-butyl cyclohexane-1,3-dicarboxylate, isoheptyl n-butyl cyclohexane-1,3-dicarboxylate, n-octyl n-butyl cyclohexane-1,3-dicarboxylate, isooctyl n-butyl cyclohexane-1,3-dicarboxylate, 2-ethylhexyl n-butyl cyclohexane-1,3-dicarboxylate, n-nonyl n-butyl cyclohexane-1,3-dicarboxylate, isononyl n-butyl cyclohexane-1,3-dicarboxylate, 2-propylheptyl n-butyl cyclohexane-1,3-dicarboxylate, n-decyl n-butyl cyclohexane-1,3-dicarboxylate, isodecyl n-butyl cyclohexane-1,3-dicarboxylate, n-undecyl n-butyl cyclohexane-1,3-dicarboxylate, isoundecyl n-butyl cyclohexane-1,3-dicarboxylate, n-dodecyl n-butyl cyclohexane-1,3-dicarboxylate, isododecyl n-butyl cyclohexane-1,3-dicarboxylate, n-tridecyl n-butyl cyclohexane-1,3-dicarboxylate, isotridecyl n-butyl cyclohexane-1,3-dicarboxylate, isobutyl tert-butyl cyclohexane-1,3-dicarboxylate, glycol tert-butyl cyclohexane-1,3-dicarboxylate, n-hexyl tert-butyl cyclohexane-1,3-dicarboxylate, isohexyl tert-butyl cyclohexane-1,3-dicarboxylate, n-heptyl tert-butyl cyclohexane-1,3-dicarboxylate, isoheptyl tert-butyl cyclohexane-1,3-dicarboxylate, n-octyl tert-butyl cyclohexane-1,3-dicarboxylate, isooctyl tert-butyl cyclohexane-1,3-dicarboxylate, 2-ethylhexyl tert-butyl cyclohexane-1,3-dicarboxylate, n-nonyl tert-butyl cyclohexane-1,3-dicarboxylate, isononyl tert-butyl cyclohexane-1,3-dicarboxylate, 2-propylheptyl tert-butyl cyclohexane-1,3-dicarboxylate, n-decyl tert-butyl cyclohexane-1,3-dicarboxylate, isodecyl tert-butyl cyclohexane-1,3-dicarboxylate, n-undecyl tert-butyl cyclohexane-1,3-dicarboxylate, isoundecyl tert-butyl cyclohexane-1,3-dicarboxylate, n-dodecyl tert-butyl cyclohexane-1,3-dicarboxylate, isododecyl tert-butyl cyclohexane-1,3-dicarboxylate, n-tridecyl tert-butyl cyclohexane-1,3-dicarboxylate, isotridecyl tert-butyl cyclohexane-1,3-dicarboxylate, glycol isobutyl cyclohexane-1,3-dicarboxylate, n-hexyl isobutyl cyclohexane-1,3-dicarboxylate, isohexyl isobutyl cyclohexane-1,3-dicarboxylate, n-heptyl isobutyl cyclohexane-1,3-dicarboxylate, isoheptyl isobutyl cyclohexane-1,3-dicarboxylate, n-octyl isobutyl cyclohexane-1,3-dicarboxylate, isooctyl isobutyl cyclohexane-1,3-dicarboxylate, 2-ethylhexyl isobutyl cyclohexane-1,3-dicarboxylate, n-nonyl isobutyl cyclohexane-1,3-dicarboxylate, isononyl isobutyl cyclohexane-1,3-dicarboxylate, 2-propylheptyl isobutyl cyclohexane-1,3-dicarboxylate, n-decyl isobutyl cyclohexane-1,3-dicarboxylate, isodecyl isobutyl cyclohexane-1,3-dicarboxylate, n-undecyl isobutyl cyclohexane-1,3-dicarboxylate, isoundecyl isobutyl cyclohexane-1,3-dicarboxylate, n-dodecyl isobutyl cyclohexane-1,3-dicarboxylate, isododecyl isobutyl cyclohexane-1,3-dicarboxylate, n-tridecyl isobutyl cyclohexane-1,3-dicarboxylate, isotridecyl isobutyl cyclohexane-1,3-dicarboxylate, n-hexylglycol cyclohexane-1,3-dicarboxylate, isohexylglycol cyclohexane-1,3-dicarboxylate, n-heptylglycol cyclohexane-1,3-dicarboxylate, isoheptylglycol cyclohexane-1,3-dicarboxylate, n-octylglycol cyclohexane-1,3-dicarboxylate, isooctylglycol cyclohexane-1,3-dicarboxylate, 2-ethylhexyl glycol cyclohexane-1,3-dicarboxylate, n-nonylglycol cyclohexane-1,3-dicarboxylate, isononylglycol cyclohexane-1,3-dicarboxylate, 2-propylheptyl glycol cyclohexane-1,3-dicarboxylate, n-decylglycol cyclohexane-1,3-dicarboxylate, isodecylglycol cyclohexane-1,3-dicarboxylate, n-undecylglycol cyclohexane-1,3-dicarboxylate, isoundecylglycol cyclohexane-1,3-dicarboxylate, n-dodecylglycol cyclohexane-1,3-dicarboxylate, isododecylglycol cyclohexane-1,3-dicarboxylate, n-tridecylglycol cyclohexane-1,3-dicarboxylate, isotridecylglycol cyclohexane-1,3-dicarboxylate, isohexyl n-hexyl cyclohexane-1,3-dicarboxylate, n-heptyl n-hexyl cyclohexane-1,3-dicarboxylate, isoheptyl n-hexyl cyclohexane-1,3-dicarboxylate, n-octyl n-hexyl cyclohexane-1,3-dicarboxylate, isooctyl n-hexyl cyclohexane-1,3-dicarboxylate, 2-ethylhexyl n-hexyl cyclohexane-1,3-dicarboxylate, n-nonyl n-hexyl cyclohexane-1,3-dicarboxylate, isononyl n-hexyl cyclohexane-1,3-dicarboxylate, 2-propylheptyl n-hexyl cyclohexane-1,3-dicarboxylate, n-decyl n-hexyl cyclohexane-1,3-dicarboxylate, isodecyl n-hexyl cyclohexane-1,3-dicarboxylate, n-undecyl n-hexyl cyclohexane-1,3-dicarboxylate, isoundecyl n-hexyl cyclohexane-1,3-dicarboxylate, n-dodecyl n-hexyl cyclohexane-1,3-dicarboxylate, isododecyl n-hexyl cyclohexane-1,3-dicarboxylate, n-tridecyl n-hexyl cyclohexane-1,3-dicarboxylate, isotridecyl n-hexyl cyclohexane-1,3-dicarboxylate, n-heptyl isohexyl cyclohexane-1,3-dicarboxylate, isoheptyl isohexyl cyclohexane-1,3-dicarboxylate, n-octyl isohexyl cyclohexane-1,3-dicarboxylate, isooctyl isohexyl cyclohexane-1,3-dicarboxylate, 2-ethylhexyl isohexyl cyclohexane-1,3-dicarboxylate, n-nonyl isohexyl cyclohexane-1,3-dicarboxylate, isononyl isohexyl cyclohexane-1,3-dicarboxylate, 2-propylheptyl isohexyl cyclohexane-1,3-dicarboxylate, n-decyl isohexyl cyclohexane-1,3-dicarboxylate, isodecyl isohexyl cyclohexane-1,3-dicarboxylate, n-undecyl isohexyl cyclohexane-1,3-dicarboxylate, isoundecyl isohexyl cyclohexane-1,3-dicarboxylate, n-dodecyl isohexyl cyclohexane-1,3-dicarboxylate, isododecyl isohexyl cyclohexane-1,3-dicarboxylate, n-tridecyl isohexyl cyclohexane-1,3-dicarboxylate, isotridecyl isohexyl cyclohexane-1,3-dicarboxylate, isoheptyl n-heptyl cyclohexane-1,3-dicarboxylate, n-octyl n-heptyl cyclohexane-1,3-dicarboxylate, isooctyl n-heptyl cyclohexane-1,3-dicarboxylate, 2-ethylhexyl n-heptyl cyclohexane-1,3-dicarboxylate, n-nonyl n-heptyl cyclohexane-1,3-dicarboxylate, isononyl n-heptyl cyclohexane-1,3-dicarboxylate, 2-propylheptyl n-heptyl cyclohexane-1,3-dicarboxylate, n-decyl n-heptyl cyclohexane-1,3-dicarboxylate, isodecyl n-heptyl cyclohexane-1,3-dicarboxylate, n-undecyl n-heptyl cyclohexane-1,3-dicarboxylate, isoundecyl n-heptyl cyclohexane-1,3-dicarboxylate, n-dodecyl n-heptyl cyclohexane-1,3-dicarboxylate, isododecyl n-heptyl cyclohexane-1,3-dicarboxylate, n-tridecyl n-heptyl cyclohexane-1,3-dicarboxylate, isotridecyl n-heptyl cyclohexane-1,3-dicarboxylate, n-octyl isoheptyl cyclohexane-1,3-dicarboxylate, isooctyl isoheptyl cyclohexane-1,3-dicarboxylate, 2-ethylhexyl isoheptyl cyclohexane-1,3-dicarboxylate, n-nonyl isoheptyl cyclohexane-1,3-dicarboxylate, isononyl isoheptyl cyclohexane-1,3-dicarboxylate, 2-propylheptyl isoheptyl cyclohexane-1,3-dicarboxylate, n-decyl isoheptyl cyclohexane-1,3-dicarboxylate, isodecyl isoheptyl cyclohexane-1,3-dicarboxylate, n-undecyl isoheptyl cyclohexane-1,3-dicarboxylate, isoundecyl isoheptyl cyclohexane-1,3-dicarboxylate, n-dodecyl isoheptyl cyclohexane-1,3-dicarboxylate, isododecyl isoheptyl cyclohexane-1,3-dicarboxylate, n-tridecyl isoheptyl cyclohexane-1,3-dicarboxylate, isotridecyl isoheptyl cyclohexane-1,3-dicarboxylate, isooctyl n-octyl cyclohexane-1,3-dicarboxylate, 2-ethylhexyl n-octyl cyclohexane-1,3-dicarboxylate, n-nonyl n-octyl cyclohexane-1,3-dicarboxylate, isononyl n-octyl cyclohexane-1,3-dicarboxylate, 2-propylheptyl n-octyl cyclohexane-1,3-dicarboxylate, n-decyl n-octyl cyclohexane-1,3-dicarboxylate, isodecyl n-octyl cyclohexane-1,3-dicarboxylate, n-undecyl n-octyl cyclohexane-1,3-dicarboxylate, isoundecyl n-octyl cyclohexane-1,3-dicarboxylate, n-dodecyl n-octyl cyclohexane-1,3-dicarboxylate, isododecyl n-octyl cyclohexane-1,3-dicarboxylate, n-tridecyl n-octyl cyclohexane-1,3-dicarboxylate, isotridecyl n-octyl cyclohexane-1,3-dicarboxylate, 2-ethylhexyl isooctyl cyclohexane-1,3-dicarboxylate, n-nonyl isooctyl cyclohexane-1,3-dicarboxylate, isononyl isooctyl cyclohexane-1,3-dicarboxylate, 2-propylheptyl isooctyl cyclohexane-1,3-dicarboxylate, n-decyl isooctyl cyclohexane-1,3-dicarboxylate, isodecyl isooctyl cyclohexane-1,3-dicarboxylate, n-undecyl isooctyl cyclohexane-1,3-dicarboxylate, isoundecyl isooctyl cyclohexane-1,3-dicarboxylate, n-dodecyl isooctyl cyclohexane-1,3-dicarboxylate, isododecyl isooctyl cyclohexane-1,3-dicarboxylate, n-tridecyl isooctyl cyclohexane-1,3-dicarboxylate, isotridecyl isooctyl cyclohexane-1,3-dicarboxylate, n-nonyl 2-ethylhexyl cyclohexane-1,3-dicarboxylate, isononyl 2-ethylhexyl cyclohexane-1,3-dicarboxylate, 2-propylheptyl 2-ethylhexyl cyclohexane-1,3-dicarboxylate, n-decyl 2-ethylhexyl cyclohexane-1,3-dicarboxylate, isodecyl 2-ethylhexyl cyclohexane-1,3-dicarboxylate, n-undecyl 2-ethylhexyl cyclohexane-1,3-dicarboxylate, isoundecyl 2-ethylhexyl cyclohexane-1,3-dicarboxylate, n-dodecyl 2-ethylhexyl cyclohexane-1,3-dicarboxylate, isododecyl 2-ethylhexyl cyclohexane-1,3-dicarboxylate, n-tridecyl 2-ethylhexyl cyclohexane-1,3-dicarboxylate, isotridecyl 2-ethylhexyl cyclohexane-1,3-dicarboxylate, isononyl n-nonyl cyclohexane-1,3-dicarboxylate, 2-propylheptyl n-nonyl cyclohexane-1,3-dicarboxylate, n-decyl n-nonyl cyclohexane-1,3-dicarboxylate, isodecyl n-nonyl cyclohexane-1,3-dicarboxylate, n-undecyl n-nonyl cyclohexane-1,3-dicarboxylate, isoundecyl n-nonyl cyclohexane-1,3-dicarboxylate, n-dodecyl n-nonyl cyclohexane-1,3-dicarboxylate, isododecyl n-nonyl cyclohexane-1,3-dicarboxylate, n-tridecyl n-nonyl cyclohexane-1,3-dicarboxylate, isotridecyl n-nonyl cyclohexane-1,3-dicarboxylate, 2-propylheptyl isononyl cyclohexane-1,3-dicarboxylate, n-decyl isononyl cyclohexane-1,3-dicarboxylate, isodecyl isononyl cyclohexane-1,3-dicarboxylate, n-undecyl isononyl cyclohexane-1,3-dicarboxylate, isoundecyl isononyl cyclohexane-1,3-dicarboxylate, n-dodecyl isononyl cyclohexane-1,3-dicarboxylate, isododecyl isononyl cyclohexane-1,3-dicarboxylate, n-tridecyl isononyl cyclohexane-1,3-dicarboxylate, isotridecyl isononyl cyclohexane-1,3-dicarboxylate, n-decyl 2-propylheptyl cyclohexane-1,3-dicarboxylate, isodecyl 2-propylheptyl cyclohexane-1,3-dicarboxylate, n-undecyl 2-propylheptyl cyclohexane-1,3-dicarboxylate, isoundecyl 2-propylheptyl cyclohexane-1,3-dicarboxylate, n-dodecyl 2-propylheptyl cyclohexane-1,3-dicarboxylate, isododecyl 2-propylheptyl cyclohexane-1,3-dicarboxylate, n-tridecyl 2-propylheptyl cyclohexane-1,3-dicarboxylate, isotridecyl 2-propylheptyl cyclohexane-1,3-dicarboxylate, isodecyl n-decyl cyclohexane-1,3-dicarboxylate, n-undecyl n-decyl cyclohexane-1,3-dicarboxylate, isoundecyl n-decyl cyclohexane-1,3-dicarboxylate, n-dodecyl n-decyl cyclohexane-1,3-dicarboxylate, isododecyl n-decyl cyclohexane-1,3-dicarboxylate, n-tridecyl n-decyl cyclohexane-1,3-dicarboxylate, isotridecyl n-decyl cyclohexane-1,3-dicarboxylate, n-undecyl isodecyl cyclohexane-1,3-dicarboxylate, isoundecyl isodecyl cyclohexane-1,3-dicarboxylate, n-dodecyl isodecyl cyclohexane-1,3-dicarboxylate, isododecyl isodecyl cyclohexane-1,3-dicarboxylate, n-tridecyl isodecyl cyclohexane-1,3-dicarboxylate, isotridecyl isodecyl cyclohexane-1,3-dicarboxylate, isoundecyl n-undecyl cyclohexane-1,3-dicarboxylate, n-dodecyl n-undecyl cyclohexane-1,3-dicarboxylate, isododecyl n-undecyl cyclohexane-1,3-dicarboxylate, n-tridecyl n-undecyl cyclohexane-1,3-dicarboxylate, isotridecyl n-undecyl cyclohexane-1,3-dicarboxylate, n-dodecyl isoundecyl cyclohexane-1,3-dicarboxylate, isododecyl isoundecyl cyclohexane-1,3-dicarboxylate, n-tridecyl isoundecyl cyclohexane-1,3-dicarboxylate, isotridecyl isoundecyl cyclohexane-1,3-dicarboxylate, isododecyl n-dodecyl cyclohexane-1,3-dicarboxylate, n-tridecyl n-dodecyl cyclohexane-1,3-dicarboxylate, isotridecyl n-dodecyl cyclohexane-1,3-dicarboxylate, n-tridecyl isododecyl cyclohexane-1,3-dicarboxylate, isotridecyl isododecyl cyclohexane-1,3-dicarboxylate, isotridecyl n-tridecyl cyclohexane-1,3-dicarboxylate, methyl cyclohexyl cyclohexane-1,3-dicarboxylate, ethyl cyclohexyl cyclohexane-1,3-dicarboxylate, n-propyl cyclohexyl cyclohexane-1,3-dicarboxylate, isopropyl cyclohexyl cyclohexane-1,3-dicarboxylate, n-butyl cyclohexyl cyclohexane-1,3-dicarboxylate, tert-butyl cyclohexyl cyclohexane-1,3-dicarboxylate, isobutyl cyclohexyl cyclohexane-1,3-dicarboxylate, glycol cyclohexyl cyclohexane-1,3-dicarboxylate, n-hexyl cyclohexyl cyclohexane-1,3-dicarboxylate, isohexyl cyclohexyl cyclohexane-1,3-dicarboxylate, n-heptyl cyclohexyl cyclohexane-1,3-dicarboxylate, isoheptyl cyclohexyl cyclohexane-1,3-dicarboxylate, n-octyl cyclohexyl cyclohexane-1,3-dicarboxylate, isooctyl cyclohexyl cyclohexane-1,3-dicarboxylate, 2-ethylhexyl cyclohexyl cyclohexane-1,3-dicarboxylate, n-nonyl cyclohexyl cyclohexane-1,3-dicarboxylate, isononyl cyclohexyl cyclohexane-1,3-dicarboxylate, 2-propylheptyl cyclohexyl cyclohexane-1,3-dicarboxylate, n-decyl cyclohexyl cyclohexane-1,3-dicarboxylate, isodecyl cyclohexyl cyclohexane-1,3-dicarboxylate, n-undecyl cyclohexyl cyclohexane-1,3-dicarboxylate, isoundecyl cyclohexyl cyclohexane-1,3-dicarboxylate, n-dodecyl cyclohexyl cyclohexane-1,3-dicarboxylate, isododecyl cyclohexyl cyclohexane-1,3-dicarboxylate, n-tridecyl cyclohexyl cyclohexane-1,3-dicarboxylate, isotridecyl cyclohexyl cyclohexane-1,3-dicarboxylate, methyl isopentyl cyclohexane-1,3-dicarboxylate, ethyl isopentyl cyclohexane-1,3-dicarboxylate, n-propyl isopentyl cyclohexane-1,3-dicarboxylate, isopropyl isopentyl cyclohexane-1,3-dicarboxylate, n-butyl isopentyl cyclohexane-1,3-dicarboxylate, tert-butyl isopentyl cyclohexane-1,3-dicarboxylate, isobutyl isopentyl cyclohexane-1,3-dicarboxylate, glycol isopentyl cyclohexane-1,3-dicarboxylate, n-hexyl isopentyl cyclohexane-1,3-dicarboxylate, isohexyl isopentyl cyclohexane-1,3-dicarboxylate, n-heptyl isopentyl cyclohexane-1,3-dicarboxylate, isoheptyl isopentyl cyclohexane-1,3-dicarboxylate, n-octyl isopentyl cyclohexane-1,3-dicarboxylate, isooctyl isopentyl cyclohexane-1,3-dicarboxylate, 2-ethylhexyl isopentyl cyclohexane-1,3-dicarboxylate, n-nonyl isopentyl cyclohexane-1,3-dicarboxylate, isononyl isopentyl cyclohexane-1,3-dicarboxylate, 2-propylheptyl isopentyl cyclohexane-1,3-dicarboxylate, n-decyl isopentyl cyclohexane-1,3-dicarboxylate, isodecyl isopentyl cyclohexane-1,3-dicarboxylate, n-undecyl isopentyl cyclohexane-1,3-dicarboxylate, isoundecyl isopentyl cyclohexane-1,3-dicarboxylate, n-dodecyl isopentyl cyclohexane-1,3-dicarboxylate, isododecyl isopentyl cyclohexane-1,3-dicarboxylate, n-tridecyl isopentyl cyclohexane-1,3-dicarboxylate, isotridecyl isopentyl cyclohexane-1,3-dicarboxylate, methyl n-pentyl cyclohexane-1,3-dicarboxylate, ethyl n-pentyl cyclohexane-1,3-dicarboxylate, n-propyl n-pentyl cyclohexane-1,3-dicarboxylate, isopropyl n-pentyl cyclohexane-1,3-dicarboxylate, n-butyl n-pentyl cyclohexane-1,3-dicarboxylate, tert-butyl n-pentyl cyclohexane-1,3-dicarboxylate, isobutyl n-pentyl cyclohexane-1,3-dicarboxylate, glycol n-pentyl cyclohexane-1,3-dicarboxylate, n-hexyl n-pentyl cyclohexane-1,3-dicarboxylate, isohexyl n-pentyl cyclohexane-1,3-dicarboxylate, n-heptyl n-pentyl cyclohexane-1,3-dicarboxylate, isoheptyl n-pentyl cyclohexane-1,3-dicarboxylate, n-octyl n-pentyl cyclohexane-1,3-dicarboxylate, isooctyl n-pentyl cyclohexane-1,3-dicarboxylate, 2-ethylhexyl n-pentyl cyclohexane-1,3-dicarboxylate, n-nonyl n-pentyl cyclohexane-1,3-dicarboxylate, isononyl n-pentyl cyclohexane-1,3-dicarboxylate, 2-propylheptyl n-pentyl cyclohexane-1,3-dicarboxylate, n-decyl n-pentyl cyclohexane-1,3-dicarboxylate, isodecyl n-pentyl cyclohexane-1,3-dicarboxylate, n-undecyl n-pentyl cyclohexane-1,3-dicarboxylate, isoundecyl n-pentyl cyclohexane-1,3-dicarboxylate, n-dodecyl n-pentyl cyclohexane-1,3-dicarboxylate, isododecyl n-pentyl cyclohexane-1,3-dicarboxylate, n-tridecyl n-pentyl cyclohexane-1,3-dicarboxylate, isotridecyl n-pentyl cyclohexane-1,3-dicarboxylate;

mixed esters of cyclohexane-1,4-dicarboxylic acid with C₁- to C₁₃-alcohols, such as, for example, ethyl methyl cyclohexane-1,4-dicarboxylate, n-propyl methyl cyclohexane-1,4-dicarboxylate, isopropyl methyl cyclohexane-1,4-dicarboxylate, n-butyl methyl cyclohexane-1,4-dicarboxylate, tert-butyl methyl cyclohexane-1,4-dicarboxylate, isobutyl methyl cyclohexane-1,4-dicarboxylate, glycol methyl cyclohexane-1,4-dicarboxylate, n-hexyl methyl cyclohexane-1,4-dicarboxylate, isohexyl methyl cyclohexane-1,4-dicarboxylate, n-heptyl methyl cyclohexane-1,4-dicarboxylate, isoheptyl methyl cyclohexane-1,4-dicarboxylate, n-octyl methyl cyclohexane-1,4-dicarboxylate, isooctyl methyl cyclohexane-1,4-dicarboxylate, 2-ethylhexyl methyl cyclohexane-1,4-dicarboxylate, n-nonyl methyl cyclohexane-1,4-dicarboxylate, isononyl methyl cyclohexane-1,4-dicarboxylate, 2-propylheptyl methyl cyclohexane-1,4-dicarboxylate, n-decyl methyl cyclohexane-1,4-dicarboxylate, isodecyl methyl cyclohexane-1,4-dicarboxylate, n-undecyl methyl cyclohexane-1,4-dicarboxylate, isoundecyl methyl cyclohexane-1,4-dicarboxylate, n-dodecyl methyl cyclohexane-1,4-dicarboxylate, isododecyl methyl cyclohexane-1,4-dicarboxylate, n-tridecyl methyl cyclohexane-1,4-dicarboxylate, isotridecyl methyl cyclohexane-1,4-dicarboxylate, n-propyl ethyl cyclohexane-1,4-dicarboxylate, isopropyl ethyl cyclohexane-1,4-dicarboxylate, n-butyl ethyl cyclohexane-1,4-dicarboxylate, tert-butyl ethyl cyclohexane-1,4-dicarboxylate, isobutyl ethyl cyclohexane-1,4-dicarboxylate, glycol ethyl cyclohexane-1,4-dicarboxylate, n-hexyl ethyl cyclohexane-1,4-dicarboxylate, isohexyl ethyl cyclohexane-1,4-dicarboxylate, n-heptyl ethyl cyclohexane-1,4-dicarboxylate, isoheptyl ethyl cyclohexane-1,4-dicarboxylate, n-octyl ethyl cyclohexane-1,4-dicarboxylate, isooctyl ethyl cyclohexane-1,4-dicarboxylate, 2-ethylhexyl ethyl cyclohexane-1,4-dicarboxylate, n-nonyl ethyl cyclohexane-1,4-dicarboxylate, isononyl ethyl cyclohexane-1,4-dicarboxylate, 2-propylheptyl ethyl cyclohexane-1,4-dicarboxylate, n-decyl ethyl cyclohexane-1,4-dicarboxylate, isodecyl ethyl cyclohexane-1,4-dicarboxylate, n-undecyl ethyl cyclohexane-1,4-dicarboxylate, isoundecyl ethyl cyclohexane-1,4-dicarboxylate, n-dodecyl ethyl cyclohexane-1,4-dicarboxylate, isododecyl ethyl cyclohexane-1,4-dicarboxylate, n-tridecyl ethyl cyclohexane-1,4-dicarboxylate, isotridecyl ethyl cyclohexane-1,4-dicarboxylate, isopropyl n-propyl cyclohexane-1,4-dicarboxylate, n-butyl n-propyl cyclohexane-1,4-dicarboxylate, tert-butyl n-propyl cyclohexane-1,4-dicarboxylate, isobutyl n-propyl cyclohexane-1,4-dicarboxylate, glycol n-propyl cyclohexane-1,4-dicarboxylate, n-hexyl n-propyl cyclohexane-1,4-dicarboxylate, isohexyl n-propyl cyclohexane-1,4-dicarboxylate, n-heptyl n-propyl cyclohexane-1,4-dicarboxylate, isoheptyl n-propyl cyclohexane-1,4-dicarboxylate, n-octyl n-propyl cyclohexane-1,4-dicarboxylate, isooctyl n-propyl cyclohexane-1,4-dicarboxylate, 2-ethylhexyl n-propyl cyclohexane-1,4-dicarboxylate, n-nonyl n-propyl cyclohexane-1,4-dicarboxylate, isononyl n-propyl cyclohexane-1,4-dicarboxylate, 2-propylheptyl n-propyl cyclohexane-1,4-dicarboxylate, n-decyl n-propyl cyclohexane-1,4-dicarboxylate, isodecyl n-propyl cyclohexane-1,4-dicarboxylate, n-undecyl n-propyl cyclohexane-1,4-dicarboxylate, isoundecyl n-propyl cyclohexane-1,4-dicarboxylate, n-dodecyl n-propyl cyclohexane-1,4-dicarboxylate, isododecyl n-propyl cyclohexane-1,4-dicarboxylate, n-tridecyl n-propyl cyclohexane-1,4-dicarboxylate, isotridecyl n-propyl cyclohexane-1,4-dicarboxylate, n-butyl isopropyl cyclohexane-1,4-dicarboxylate, tert-butyl isopropyl cyclohexane-1,4-dicarboxylate, isobutyl isopropyl cyclohexane-1,4-dicarboxylate, glycol isopropyl cyclohexane-1,4-dicarboxylate, n-hexyl isopropyl cyclohexane-1,4-dicarboxylate, isohexyl isopropyl cyclohexane-1,4-dicarboxylate, n-heptyl isopropyl cyclohexane-1,4-dicarboxylate, isoheptyl isopropyl cyclohexane-1,4-dicarboxylate, n-octyl isopropyl cyclohexane-1,4-dicarboxylate, isooctyl isopropyl cyclohexane-1,4-dicarboxylate, 2-ethylhexyl isopropyl cyclohexane-1,4-dicarboxylate, n-nonyl isopropyl cyclohexane-1,4-dicarboxylate, isononyl isopropyl cyclohexane-1,4-dicarboxylate, 2-propylheptyl isopropyl cyclohexane-1,4-dicarboxylate, n-decyl isopropyl cyclohexane-1,4-dicarboxylate, isodecyl isopropyl cyclohexane-1,4-dicarboxylate, n-undecyl isopropyl cyclohexane-1,4-dicarboxylate, isoundecyl isopropyl cyclohexane-1,4-dicarboxylate, n-dodecyl isopropyl cyclohexane-1,4-dicarboxylate, isododecyl isopropyl cyclohexane-1,4-dicarboxylate, n-tridecyl isopropyl cyclohexane-1,4-dicarboxylate, isotridecyl isopropyl cyclohexane-1,4-dicarboxylate, tert-butyl n-butyl cyclohexane-1,4-dicarboxylate, isobutyl n-butyl cyclohexane-1,4-dicarboxylate, glycol n-butyl cyclohexane-1,4-dicarboxylate, n-hexyl n-butyl cyclohexane-1,4-dicarboxylate, isohexyl n-butyl cyclohexane-1,4-dicarboxylate, n-heptyl n-butyl cyclohexane-1,4-dicarboxylate, isoheptyl n-butyl cyclohexane-1,4-dicarboxylate, n-octyl n-butyl cyclohexane-1,4-dicarboxylate, isooctyl n-butyl cyclohexane-1,4-dicarboxylate, 2-ethylhexyl n-butyl cyclohexane-1,4-dicarboxylate, n-nonyl n-butyl cyclohexane-1,4-dicarboxylate, isononyl n-butyl cyclohexane-1,4-dicarboxylate, 2-propylheptyl n-butyl cyclohexane-1,4-dicarboxylate, n-decyl n-butyl cyclohexane-1,4-dicarboxylate, isodecyl n-butyl cyclohexane-1,4-dicarboxylate, n-undecyl n-butyl cyclohexane-1,4-dicarboxylate, isoundecyl n-butyl cyclohexane-1,4-dicarboxylate, n-dodecyl n-butyl cyclohexane-1,4-dicarboxylate, isododecyl n-butyl cyclohexane-1,4-dicarboxylate, n-tridecyl n-butyl cyclohexane-1,4-dicarboxylate, isotridecyl n-butyl cyclohexane-1,4-dicarboxylate, isobutyl tert-butyl cyclohexane-1,4-dicarboxylate, glycol tert-butyl cyclohexane-1,4-dicarboxylate, n-hexyl tert-butyl cyclohexane-1,4-dicarboxylate, isohexyl tert-butyl cyclohexane-1,4-dicarboxylate, n-heptyl tert-butyl cyclohexane-1,4-dicarboxylate, isoheptyl tert-butyl cyclohexane-1,4-dicarboxylate, n-octyl tert-butyl cyclohexane-1,4-dicarboxylate, isooctyl tert-butyl cyclohexane-1,4-dicarboxylate, 2-ethylhexyl tert-butyl cyclohexane-1,4-dicarboxylate, n-nonyl tert-butyl cyclohexane-1,4-dicarboxylate, isononyl tert-butyl cyclohexane-1,4-dicarboxylate, 2-propylheptyl tert-butyl cyclohexane-1,4-dicarboxylate, n-decyl tert-butyl cyclohexane-1,4-dicarboxylate, isodecyl tert-butyl cyclohexane-1,4-dicarboxylate, n-undecyl tert-butyl cyclohexane-1,4-dicarboxylate, isoundecyl tert-butyl cyclohexane-1,4-dicarboxylate, n-dodecyl tert-butyl cyclohexane-1,4-dicarboxylate, isododecyl tert-butyl cyclohexane-1,4-dicarboxylate, n-tridecyl tert-butyl cyclohexane-1,4-dicarboxylate, isotridecyl tert-butyl cyclohexane-1,4-dicarboxylate, glycol isobutyl cyclohexane-1,4-dicarboxylate, n-hexyl isobutyl cyclohexane-1,4-dicarboxylate, isohexyl isobutyl cyclohexane-1,4-dicarboxylate, n-heptyl isobutyl cyclohexane-1,4-dicarboxylate, isoheptyl isobutyl cyclohexane-1,4-dicarboxylate, n-octyl isobutyl cyclohexane-1,4-dicarboxylate, isooctyl isobutyl cyclohexane-1,4-dicarboxylate, 2-ethylhexyl isobutyl cyclohexane-1,4-dicarboxylate, n-nonyl isobutyl cyclohexane-1,4-dicarboxylate, isononyl isobutyl cyclohexane-1,4-dicarboxylate, 2-propylheptyl isobutyl cyclohexane-1,4-dicarboxylate, n-decyl isobutyl cyclohexane-1,4-dicarboxylate, isodecyl isobutyl cyclohexane-1,4-dicarboxylate, n-undecyl isobutyl cyclohexane-1,4-dicarboxylate, isoundecyl isobutyl cyclohexane-1,4-dicarboxylate, n-dodecyl isobutyl cyclohexane-1,4-dicarboxylate, isododecyl isobutyl cyclohexane-1,4-dicarboxylate, n-tridecyl isobutyl cyclohexane-1,4-dicarboxylate, isotridecyl isobutyl cyclohexane-1,4-dicarboxylate, n-hexylglycol cyclohexane-1,4-dicarboxylate, isohexylglycol cyclohexane-1,4-dicarboxylate, n-heptylglycol cyclohexane-1,4-dicarboxylate, isoheptylglycol cyclohexane-1,4-dicarboxylate, n-octylglycol cyclohexane-1,4-dicarboxylate, isooctylglycol cyclohexane-1,4-dicarboxylate, 2-ethylhexylglycol cyclohexane-1,4-dicarboxylate, n-nonylglycol cyclohexane-1,4-dicarboxylate, isononylglycol cyclohexane-1,4-dicarboxylate, 2-propylheptylglycol cyclohexane-1,4-dicarboxylate, n-decylglycol cyclohexane-1,4-dicarboxylate, isodecylglycol cyclohexane-1,4-dicarboxylate, n-undecylglycol cyclohexane-1,4-dicarboxylate, isoundecylglycol cyclohexane-1,4-dicarboxylate, n-dodecylglycol cyclohexane-1,4-dicarboxylate, isododecylglycol cyclohexane-1,4-dicarboxylate, n-tridecylglycol cyclohexane-1,4-dicarboxylate, isotridecylglycol cyclohexane-1,4-dicarboxylate, isohexyl n-hexyl cyclohexane-1,4-dicarboxylate, n-heptyl n-hexyl cyclohexane-1,4-dicarboxylate, isoheptyl n-hexyl cyclohexane-1,4-dicarboxylate, n-octyl n-hexyl cyclohexane-1,4-dicarboxylate, isooctyl n-hexyl cyclohexane-1,4-dicarboxylate, 2-ethylhexyl n-hexyl cyclohexane-1,4-dicarboxylate, n-nonyl n-hexyl cyclohexane-1,4-dicarboxylate, isononyl n-hexyl cyclohexane-1,4-dicarboxylate, 2-propylheptyl n-hexyl cyclohexane-1,4-dicarboxylate, n-decyl n-hexyl cyclohexane-1,4-dicarboxylate, isodecyl n-hexyl cyclohexane-1,4-dicarboxylate, n-undecyl n-hexyl cyclohexane-1,4-dicarboxylate, isoundecyl n-hexyl cyclohexane-1,4-dicarboxylate, n-dodecyl n-hexyl cyclohexane-1,4-dicarboxylate, isododecyl n-hexyl cyclohexane-1,4-dicarboxylate, n-tridecyl n-hexyl cyclohexane-1,4-dicarboxylate, isotridecyl n-hexyl cyclohexane-1,4-dicarboxylate, n-heptyl isohexyl cyclohexane-1,4-dicarboxylate, isoheptyl isohexyl cyclohexane-1,4-dicarboxylate, n-octyl isohexyl cyclohexane-1,4-dicarboxylate, isooctyl isohexyl cyclohexane-1,4-dicarboxylate, 2-ethylhexyl isohexyl cyclohexane-1,4-dicarboxylate, n-nonyl isohexyl cyclohexane-1,4-dicarboxylate, isononyl isohexyl cyclohexane-1,4-dicarboxylate, 2-propylheptyl isohexyl cyclohexane-1,4-dicarboxylate, n-decyl isohexyl cyclohexane-1,4-dicarboxylate, isodecyl isohexyl cyclohexane-1,4-dicarboxylate, n-undecyl isohexyl cyclohexane-1,4-dicarboxylate, isoundecyl isohexyl cyclohexane-1,4-dicarboxylate, n-dodecyl isohexyl cyclohexane-1,4-dicarboxylate, isododecyl isohexyl cyclohexane-1,4-dicarboxylate, n-tridecyl isohexyl cyclohexane-1,4-dicarboxylate, isotridecyl isohexyl cyclohexane-1,4-dicarboxylate, isoheptyl n-heptyl cyclohexane-1,4-dicarboxylate, n-octyl n-heptyl cyclohexane-1,4-dicarboxylate, isooctyl n-heptyl cyclohexane-1,4-dicarboxylate, 2-ethylhexyl n-heptyl cyclohexane-1,4-dicarboxylate, n-nonyl n-heptyl cyclohexane-1,4-dicarboxylate, isononyl n-heptyl cyclohexane-1,4-dicarboxylate, 2-propylheptyl n-heptyl cyclohexane-1,4-dicarboxylate, n-decyl n-heptyl cyclohexane-1,4-dicarboxylate, isodecyl n-heptyl cyclohexane-1,4-dicarboxylate, n-undecyl n-heptyl cyclohexane-1,4-dicarboxylate, isoundecyl n-heptyl cyclohexane-1,4-dicarboxylate, n-dodecyl n-heptyl cyclohexane-1,4-dicarboxylate, isododecyl n-heptyl cyclohexane-1,4-dicarboxylate, n-tridecyl n-heptyl cyclohexane-1,4-dicarboxylate, isotridecyl n-heptyl cyclohexane-1,4-dicarboxylate, n-octyl isoheptyl cyclohexane-1,4-dicarboxylate, isooctyl isoheptyl cyclohexane-1,4-dicarboxylate, 2-ethylhexyl isoheptyl cyclohexane-1,4-dicarboxylate, n-nonyl isoheptyl cyclohexane-1,4-dicarboxylate, isononyl isoheptyl cyclohexane-1,4-dicarboxylate, 2-propylheptyl isoheptyl cyclohexane-1,4-dicarboxylate, n-decyl isoheptyl cyclohexane-1,4-dicarboxylate, isodecyl isoheptyl cyclohexane-1,4-dicarboxylate, n-undecyl isoheptyl cyclohexane-1,4-dicarboxylate, isoundecyl isoheptyl cyclohexane-1,4-dicarboxylate, n-dodecyl isoheptyl cyclohexane-1,4-dicarboxylate, isododecyl isoheptyl cyclohexane-1,4-dicarboxylate, n-tridecyl isoheptyl cyclohexane-1,4-dicarboxylate, isotridecyl isoheptyl cyclohexane-1,4-dicarboxylate, isooctyl n-octyl cyclohexane-1,4-dicarboxylate, 2-ethylhexyl n-octyl cyclohexane-1,4-dicarboxylate, n-nonyl n-octyl cyclohexane-1,4-dicarboxylate, isononyl n-octyl cyclohexane-1,4-dicarboxylate, 2-propylheptyl n-octyl cyclohexane-1,4-dicarboxylate, n-decyl n-octyl cyclohexane-1,4-dicarboxylate, isodecyl n-octyl cyclohexane-1,4-dicarboxylate, n-undecyl n-octyl cyclohexane-1,4-dicarboxylate, isoundecyl n-octyl cyclohexane-1,4-dicarboxylate, n-dodecyl n-octyl cyclohexane-1,4-dicarboxylate, isododecyl n-octyl cyclohexane-1,4-dicarboxylate, n-tridecyl n-octyl cyclohexane-1,4-dicarboxylate, isotridecyl n-octyl cyclohexane-1,4-dicarboxylate, 2-ethylhexyl isooctyl cyclohexane-1,4-dicarboxylate, n-nonyl isooctyl cyclohexane-1,4-dicarboxylate, isononyl isooctyl cyclohexane-1,4-dicarboxylate, 2-propylheptyl isooctyl cyclohexane-1,4-dicarboxylate, n-dodecyl isooctyl cyclohexane-1,4-dicarboxylate, isodecyl isooctyl cyclohexane-1,4-dicarboxylate, n-undecyl isooctyl cyclohexane-1,4-dicarboxylate, isoundecyl isooctyl cyclohexane-1,4-dicarboxylate, n-dodecyl isooctyl cyclohexane-1,4-dicarboxylate, isododecyl isooctyl cyclohexane-1,4-dicarboxylate, n-tridecyl isooctyl cyclohexane-1,4-dicarboxylate, isotridecyl isooctyl cyclohexane-1,4-dicarboxylate, n-nonyl 2-ethylhexyl cyclohexane-1,4-dicarboxylate, isononyl 2-ethylhexyl cyclohexane-1,4-dicarboxylate, 2-propylheptyl 2-ethylhexyl cyclohexane-1,4-dicarboxylate, n-decyl 2-ethylhexyl cyclohexane-1,4-dicarboxylate, isodecyl 2-ethylhexyl cyclohexane-1,4-dicarboxylate, n-undecyl 2-ethylhexyl cyclohexane-1,4-dicarboxylate, isoundecyl 2-ethylhexyl cyclohexane-1,4-dicarboxylate, n-dodecyl 2-ethylhexyl cyclohexane-1,4-dicarboxylate, isododecyl 2-ethylhexyl cyclohexane-1,4-dicarboxylate, n-tridecyl 2-ethylhexyl cyclohexane-1,4-dicarboxylate, isotridecyl 2-ethylhexyl cyclohexane-1,4-dicarboxylate, isononyl n-nonyl cyclohexane-1,4-dicarboxylate, 2-propylheptyl n-nonyl cyclohexane-1,4-dicarboxylate, n-decyl n-nonyl cyclohexane-1,4-dicarboxylate, isodecyl n-nonyl cyclohexane-1,4-dicarboxylate, n-undecyl n-nonyl cyclohexane-1,4-dicarboxylate, isoundecyl n-nonyl cyclohexane-1,4-dicarboxylate, n-dodecyl n-nonyl cyclohexane-1,4-dicarboxylate, isododecyl n-nonyl cyclohexane-1,4-dicarboxylate, n-tridecyl n-nonyl cyclohexane-1,4-dicarboxylate, isotridecyl n-nonyl cyclohexane-1,4-dicarboxylate, 2-propylheptyl isononyl cyclohexane-1,4-dicarboxylate, n-decyl isononyl cyclohexane-1,4-dicarboxylate, isodecyl isononyl cyclohexane-1,4-dicarboxylate, n-undecyl isononyl cyclohexane-1,4-dicarboxylate, isoundecyl isononyl cyclohexane-1,4-dicarboxylate, n-dodecyl isononyl cyclohexane-1,4-dicarboxylate, isododecyl isononyl cyclohexane-1,4-dicarboxylate, n-tridecyl isononyl cyclohexane-1,4-dicarboxylate, isotridecyl isononyl cyclohexane-1,4-dicarboxylate, n-decyl 2-propylheptyl cyclohexane-1,4-dicarboxylate, isodecyl 2-propylheptyl cyclohexane-1,4-dicarboxylate, n-undecyl 2-propylheptyl cyclohexane-1,4-dicarboxylate, isoundecyl 2-propylheptyl cyclohexane-1,4-dicarboxylate, n-dodecyl 2-propylheptyl cyclohexane-1,4-dicarboxylate, isododecyl 2-propylheptyl cyclohexane-1,4-dicarboxylate, n-tridecyl 2-propylheptyl cyclohexane-1,4-dicarboxylate, isotridecyl 2-propylheptyl cyclohexane-1,4-dicarboxylate, isodecyl n-decyl cyclohexane-1,4-dicarboxylate, n-undecyl n-decyl cyclohexane-1,4-dicarboxylate, isoundecyl n-decyl cyclohexane-1,4-dicarboxylate, n-dodecyl n-decyl cyclohexane-1,4-dicarboxylate, isododecyl n-decyl cyclohexane-1,4-dicarboxylate, n-tridecyl n-decyl cyclohexane-1,4-dicarboxylate, isotridecyl n-decyl cyclohexane-1,4-dicarboxylate, n-undecyl isodecyl cyclohexane-1,4-dicarboxylate, isoundecyl isodecyl cyclohexane-1,4-dicarboxylate, n-dodecyl isodecyl cyclohexane-1,4-dicarboxylate, isododecyl isodecyl cyclohexane-1,4-dicarboxylate, n-tridecyl isodecyl cyclohexane-1,4-dicarboxylate, isotridecyl isodecyl cyclohexane-1,4-dicarboxylate, isoundecyl n-undecyl cyclohexane-1,4-dicarboxylate, n-dodecyl n-undecyl cyclohexane-1,4-dicarboxylate, isododecyl n-undecyl cyclohexane-1,4-dicarboxylate, n-tridecyl n-undecyl cyclohexane-1,4-dicarboxylate, isotridecyl n-undecyl cyclohexane-1,4-dicarboxylate, n-dodecyl isoundecyl cyclohexane-1,4-dicarboxylate, isododecyl isoundecyl cyclohexane-1,4-dicarboxylate, n-tridecyl isoundecyl cyclohexane-1,4-dicarboxylate, isotridecyl isoundecyl cyclohexane-1,4-dicarboxylate, isododecyl n-dodecyl cyclohexane-1,4-dicarboxylate, n-tridecyl n-dodecyl cyclohexane-1,4-dicarboxylate, isotridecyl n-dodecyl cyclohexane-1,4-dicarboxylate, n-tridecyl isododecyl cyclohexane-1,4-dicarboxylate, isotridecyl isododecyl cyclohexane-1,4-dicarboxylate, isotridecyl n-tridecyl cyclohexane-1,4-dicarboxylate, methyl cyclohexyl cyclohexane-1,4-dicarboxylate, ethyl cyclohexyl cyclohexane-1,4-dicarboxylate, n-propyl cyclohexyl cyclohexane-1,4-dicarboxylate, isopropyl cyclohexyl cyclohexane-1,4-dicarboxylate, n-butyl cyclohexyl cyclohexane-1,4-dicarboxylate, tert-butyl cyclohexyl cyclohexane-1,4-dicarboxylate, isobutyl cyclohexyl cyclohexane-1,4-dicarboxylate, glycol cyclohexyl cyclohexane-1,4-dicarboxylate, n-hexyl cyclohexyl cyclohexane-1,4-dicarboxylate, isohexyl cyclohexyl cyclohexane-1,4-dicarboxylate, n-heptyl cyclohexyl cyclohexane-1,4-dicarboxylate, isoheptyl cyclohexyl cyclohexane-1,4-dicarboxylate, n-octyl cyclohexyl cyclohexane-1,4-dicarboxylate, isooctyl cyclohexyl cyclohexane-1,4-dicarboxylate, 2-ethylhexyl cyclohexyl cyclohexane-1,4-dicarboxylate, n-nonyl cyclohexyl cyclohexane-1,4-dicarboxylate, isononyl cyclohexyl cyclohexane-1,4-dicarboxylate, 2-propylheptyl cyclohexyl cyclohexane-1,4-dicarboxylate, n-decyl cyclohexyl cyclohexane-1,4-dicarboxylate, isodecyl cyclohexyl cyclohexane-1,4-dicarboxylate, n-undecyl cyclohexyl cyclohexane-1,4-dicarboxylate, isoundecyl cyclohexyl cyclohexane-1,4-dicarboxylate, n-dodecyl cyclohexyl cyclohexane-1,4-dicarboxylate, isododecyl cyclohexyl cyclohexane-1,4-dicarboxylate, n-tridecyl cyclohexyl cyclohexane-1,4-dicarboxylate, isotridecyl cyclohexyl cyclohexane-1,4-dicarboxylate, methyl isopentyl cyclohexane-1,4-dicarboxylate, ethyl isopentyl cyclohexane-1,4-dicarboxylate, n-propyl isopentyl cyclohexane-1,4-dicarboxylate, isopropyl isopentyl cyclohexane-1,4-dicarboxylate, n-butyl isopentyl cyclohexane-1,4-dicarboxylate, tert-butyl isopentyl cyclohexane-1,4-dicarboxylate, isobutyl isopentyl cyclohexane-1,4-dicarboxylate, glycol isopentyl cyclohexane-1,4-dicarboxylate, n-hexyl isopentyl cyclohexane-1,4-dicarboxylate, isohexyl isopentyl cyclohexane-1,4-dicarboxylate, n-heptyl isopentyl cyclohexane-1,4-dicarboxylate, isoheptyl isopentyl cyclohexane-1,4-dicarboxylate, n-octyl isopentyl cyclohexane-1,4-dicarboxylate, isooctyl isopentyl cyclohexane-1,4-dicarboxylate, 2-ethylhexyl isopentyl cyclohexane-1,4-dicarboxylate, n-nonyl isopentyl cyclohexane-1,4-dicarboxylate, isononyl isopentyl cyclohexane-1,4-dicarboxylate, 2-propylheptyl isopentyl cyclohexane-1,4-dicarboxylate, n-decyl isopentyl cyclohexane-1,4-dicarboxylate, isodecyl isopentyl cyclohexane-1,4-dicarboxylate, n-undecyl isopentyl cyclohexane-1,4-dicarboxylate, isoundecyl isopentyl cyclohexane-1,4-dicarboxylate, n-dodecyl isopentyl cyclohexane-1,4-dicarboxylate, isododecyl isopentyl cyclohexane-1,4-dicarboxylate, n-tridecyl isopentyl cyclohexane-1,4-dicarboxylate, isotridecyl isopentyl cyclohexane-1,4-dicarboxylate, methyl n-pentyl cyclohexane-1,4-dicarboxylate, ethyl n-pentyl cyclohexane-1,4-dicarboxylate, n-propyl n-pentyl cyclohexane-1,4-dicarboxylate, isopropyl n-pentyl cyclohexane-1,4-dicarboxylate, n-butyl n-pentyl cyclohexane-1,4-dicarboxylate, tert-butyl n-pentyl cyclohexane-1,4-dicarboxylate, isobutyl n-pentyl cyclohexane-1,4-dicarboxylate, glycol n-pentyl cyclohexane-1,4-dicarboxylate, n-hexyl n-pentyl cyclohexane-1,4-dicarboxylate, isohexyl n-pentyl cyclohexane-1,4-dicarboxylate, n-heptyl n-pentyl cyclohexane-1,4-dicarboxylate, isoheptyl n-pentyl cyclohexane-1,4-dicarboxylate, n-octyl n-pentyl cyclohexane-1,4-dicarboxylate, isooctyl n-pentyl cyclohexane-1,4-dicarboxylate, 2-ethylhexyl n-pentyl cyclohexane-1,4-dicarboxylate, n-nonyl n-pentyl cyclohexane-1,4-dicarboxylate, isononyl n-pentyl cyclohexane-1,4-dicarboxylate, 2-propylheptyl, n-pentyl cyclohexane-1,4-dicarboxylate, n-decyl n-pentyl cyclohexane-1,4-dicarboxylate, isodecyl n-pentyl cyclohexane-1,4-dicarboxylate, n-undecyl n-pentyl cyclohexane-1,4-dicarboxylate, isoundecyl n-pentyl cyclohexane-1,4-dicarboxylate, n-dodecyl n-pentyl cyclohexane-1,4-dicarboxylate, isododecyl n-pentyl cyclohexane-1,4-dicarboxylate, n-tridecyl n-pentyl cyclohexane-1,4-dicarboxylate, isotridecyl n-pentyl cyclohexane-1,4-dicarboxylate; alkyl cyclohexane-1,3-dicarboxylates, such as, for example, monomethyl cyclohexane-1,3-dicarboxylate, dimethyl cyclohexane-1,3-dicarboxylate, diethyl cyclohexane-1,3-dicarboxylate, di-n-propyl cyclohexane-1,3-dicarboxylate, di-n-butyl cyclohexane-1,3-dicarboxylate, di-tert-butyl cyclohexane-1,3-dicarboxylate, diisobutyl cyclohexane-1,3-dicarboxylate, monoglycol cyclohexane-1,3-dicarboxylate, diglycol cyclohexane-1,3-dicarboxylate, di-n-octyl cyclohexane-1,3-dicarboxylate, diisooctyl cyclohexane-1,3-dicarboxylate, di-2-ethylhexyl cyclohexane-1,3-dicarboxylate, di-n-nonyl cyclohexane-1,3-dicarboxylate, diisononyl cyclohexane-1,3-dicarboxylate, di-n-decyl cyclohexane-1,3-dicarboxylate, diisodecyl cyclohexane-1,3-dicarboxylate, di-n-undecyl cyclohexane-1,3-dicarboxylate, diisododecyl cyclohexane-1,3-dicarboxylate, di-n-octadecyl cyclohexane-1,3-dicarboxylate, diisooctadecyl cyclohexane-1,3-dicarboxylate, di-n-eicosyl cyclohexane-1,3-dicarboxylate, monocyclohexyl cyclohexane-1,3-dicarboxylate, dicyclohexyl cyclohexane-1,3-dicarboxylate, diisopropyl cyclohexane-1,3-dicarboxylate, di-n-hexyl cyclohexane-1,3-dicarboxylate, diisohexyl cyclohexane-1,3-dicarboxylate, di-n-heptyl cyclohexane-1,3-dicarboxylate, diisoheptyl cyclohexane-1,3-dicarboxylate, di-2-propylheptyl cyclohexane-1,3-dicarboxylate, diisoundecyl cyclohexane-1,3-dicarboxylate, di-n-dodecyl cyclohexane-1,3-dicarboxylate, di-n-tridecyl cyclohexane-1,3-dicarboxylate, diisotridecyl cyclohexane-1,3-dicarboxylate, di-n-pentyl cyclohexane-1,3-dicarboxylate, diisopentyl cyclohexane-1,3-dicarboxylate;

alkyl cyclohexane-1,2,4-tricarboxylates, such as, for example, monomethyl cyclohexane-1,2,4-tricarboxylate, dimethyl cyclohexane-1,2,4-tricarboxylate, diethyl cyclohexane-1,2,4-tricarboxylate, di-n-propyl cyclohexane-1,2,4-tricarboxylate, diisopropyl cyclohexane-1,2,4-tricarboxylate, di-n-butyl cyclohexane-1,2,4-tricarboxylate, di-tert-butyl cyclohexane-1,2,4-tricarboxylate, diisobutyl cyclohexane-1,2,4-tricarboxylate, monoglycol cyclohexane-1,2,4-tricarboxylate, diglycol cyclohexane-1,2,4-tricarboxylate, di-n-octyl cyclohexane-1,2,4-tricarboxylate, diisooctyl cyclohexane-1,2,4-tricarboxylate, di-2-ethylhexyl cyclohexane-1,2,4-tricarboxylate, di-n-nonyl cyclohexane-1,2,4-tricarboxylate, diisononyl cyclohexane-1,2,4-tricarboxylate, di-n-decyl cyclohexane-1,2,4-tricarboxylate, diisodecyl cyclohexane-1,2,4-tricarboxylate, di-n-undecyl cyclohexane-1,2,4-tricarboxylate, diisododecyl cyclohexane-1,2,4-tricarboxylate, di-n-octadecyl cyclohexane-1,2,4-tricarboxylate, diisooctadecyl cyclohexane-1,2,4-tricarboxylate, di-n-eicosyl cyclohexane-1,2,4-tricarboxylate, monocyclohexyl cyclohexane-1,2,4-tricarboxylate, dicyclohexyl cyclohexane-1,2,4-tricarboxylate and trimethyl cyclohexane-1,2,4-tricarboxylate, triethyl cyclohexane-1,2,4-tricarboxylate, tri-n-propyl cyclohexane-1,2,4-tricarboxylate, tri-n-butyl cyclohexane-1,2,4-tricarboxylate, tri-tert-butyl cyclohexane-1,2,4-tricarboxylate, triisobutyl cyclohexane-1,2,4-tricarboxylate, triglycol cyclohexane-1,2,4-tricarboxylate, tri-n-octyl cyclohexane-1,2,4-tricarboxylate, triisooctyl cyclohexane-1,2,4-tricarboxylate, tri-2-ethylhexyl cyclohexane-1,2,4-tricarboxylate, tri-n-nonyl cyclohexane-1,2,4-tricarboxylate, triisononyl cyclohexane-1,2,4-tricarboxylate, tri-n-decyl cyclohexane-1,2,4-tricarboxylate, triisododecyl cyclohexane-1,2,4-tricarboxylate, tri-n-undecyl cyclohexane-1,2,4-tricarboxylate, triisododecyl cyclohexane-1,2,4-tricarboxylate, tri-n-octadecyl cyclohexane-1,2,4-tricarboxylate, triisooctadecyl cyclohexane-1,2,4-tricarboxylate, tri-n-eicosyl cyclohexane-1,2,4-tricarboxylate, tricyclohexyl cyclohexane-1,2,4-tricarboxylate, di-n-hexyl cyclohexane-1,2,4-tricarboxylate, diisohexyl cyclohexane-1,2,4-tricarboxylate, tri-n-hexyl cyclohexane-1,2,4-tricarboxylate, triisohexyl cyclohexane-1,2,4-tricarboxylate, di-n-heptyl cyclohexane-1,2,4-tricarboxylate, diisoheptyl cyclohexane-1,2,4-tricarboxylate, tri-n-heptyl cyclohexane-1,2,4-tricarboxylate, triisoheptyl cyclohexane-1,2,4-tricarboxylate, di-n-pentyl cyclohexane-1,2,4-tricarboxylate, diisopentyl cyclohexane-1,2,4-tricarboxylate, tri-n-pentyl cyclohexane-1,2,4-tricarboxylate, triisopentyl cyclohexane-1,2,4-tricarboxylate, di-n-tridecyl cyclohexane-1,2,4-tricarboxylate, diisotridecyl cyclohexane-1,2,4-tricarboxylate, tri-n-tridecyl cyclohexane-1,2,4-tricarboxylate, triisotridecyl cyclohexane-1,2,4-tricarboxylate, di-n-dodecyl cyclohexane-1,2,4-tricarboxylate, diisoundecyl cyclohexane-1,2,4-tricarboxylate, tri-n-dodecyl cyclohexane-1,2,4-tricarboxylate, triisoundecyl cyclohexane-1,2,4-tricarboxylate, triisopropyl cyclohexane-1,2,4-tricarboxylate;

alkyl cyclohexane-1,3,5-tricarboxylates, such as, for example, monomethyl cyclohexane-1,3,5-tricarboxylate, dimethyl cyclohexane-1,3,5-tricarboxylate, diethyl cyclohexane-1,3,5-tricarboxylate, di-n-propyl cyclohexane-1,3,5-tricarboxylate, di-n-butyl cyclohexane-1,3,5-tricarboxylate, di-tert-butyl cyclohexane-1,3,5-tricarboxylate, diisobutyl cyclohexane-1,3,5-tricarboxylate, monoglycol cyclohexane-1,3,5-tricarboxylate, diglycol cyclohexane-1,3,5-tricarboxylate, di-n-octyl cyclohexane-1,3,5-tricarboxylate, diisooctyl cyclohexane-1,3,5-tricarboxylate, di-2-ethylhexyl cyclohexane-1,3,5-tricarboxylate, di-n-nonyl cyclohexane-1,3,5-tricarboxylate, diisononyl cyclohexane-1,3,5-tricarboxylate, di-n-decyl cyclohexane-1,3,5-tricarboxylate, diisodecyl cyclohexane-1,3,5-tricarboxylate, di-n-undecyl cyclohexane-1,3,5-tricarboxylate, diisododecyl cyclohexane-1,3,5-tricarboxylate, di-n-octadecyl cyclohexane-1,3,5-tricarboxylate, diisooctadecyl cyclohexane-1,3,5-tricarboxylate, di-n-eicosyl cyclohexane-1,3,5-tricarboxylate, monocyclohexyl cyclohexane-1,3,5-tricarboxylate, dicyclohexyl cyclohexane-1,3,5-tricarboxylate, and trimethyl cyclohexane-1,3,5-tricarboxylate, triethyl cyclohexane-1,3,5-tricarboxylate, tri-n-propyl cyclohexane-1,3,5-tricarboxylate, tri-n-butyl cyclohexane-1,3,5-tricarboxylate, tri-tert-butyl cyclohexane-1,3,5-tricarboxylate, triisobutyl cyclohexane-1,3,5-tricarboxylate, triglycol cyclohexane-1,3,5-tricarboxylate, tri-n-octyl cyclohexane-1,3,5-tricarboxylate, triisooctyl cyclohexane-1,3,5-tricarboxylate, tri-2-ethylhexyl cyclohexane-1,3,5-tricarboxylate, tri-n-nonyl cyclohexane-1,3,5-tricarboxylate, triisononyl cyclohexane-1,3,5-tricarboxylate, tri-n-decyl cyclohexane-1,3,5-tricarboxylate, triisododecyl cyclohexane-1,3,5-tricarboxylate, tri-n-undecyl cyclohexane-1,3,5-tricarboxylate, triisododecyl cyclohexane-1,3,5-tricarboxylate, tri-n-octadecyl cyclohexane-1,3,5-tricarboxylate, triisooctadecyl cyclohexane-1,3,5-tricarboxylate, tri-n-eicosyl cyclohexane-1,3,5-tricarboxylate, tricyclohexyl cyclohexane-1,3,5-tricarboxylate, di-n-hexyl cyclohexane-1,3,5-tricarboxylate, diisohexyl cyclohexane-1,3,5-tricarboxylate, tri-n-hexyl cyclohexane-1,3,5-tricarboxylate, triisohexyl cyclohexane-1,3,5-tricarboxylate, di-n-heptyl cyclohexane-1,3,5-tricarboxylate, diisoheptyl cyclohexane-1,3,5-tricarboxylate, tri-n-heptyl cyclohexane-1,3,5-tricarboxylate, triisoheptyl cyclohexane-1,3,5-tricarboxylate, di-n-pentyl cyclohexane-1,3,5-tricarboxylate, diisopentyl cyclohexane-1,3,5-tricarboxylate, tri-n-pentyl cyclohexane-1,3,5-tricarboxylate, triisopentyl cyclohexane-1,3,5-tricarboxylate, di-n-tridecyl cyclohexane-1,3,5-tricarboxylate, diisotridecyl cyclohexane-1,3,5-tricarboxylate, tri-n-tridecyl cyclohexane-1,3,5-tricarboxylate, triisotridecyl cyclohexane-1,3,5-tricarboxylate, di-n-dodecyl cyclohexane-1,3,5-tricarboxylate, diisoundecyl cyclohexane-1,3,5-tricarboxylate, tri-n-dodecyl cyclohexane-1,3,5-tricarboxylate, triisoundecyl cyclohexane-1,3,5-tricarboxylate, triisopropyl cyclohexane-1,3,5-tricarboxylate;

alkyl cyclohexane-1,2,3-tricarboxylates, such as, for example, monomethyl cyclohexane-1,2,3-tricarboxylate, dimethyl cyclohexane-1,2,3-tricarboxylate, diethyl cyclohexane-1,2,3-tricarboxylate, di-n-propyl cyclohexane-1,2,3-tricarboxylate, di-n-butyl cyclohexane-1,2,3-tricarboxylate, di-tert-butyl cyclohexane-1,2,3-tricarboxylate, diisobutyl cyclohexane-1,2,3-tricarboxylate, monoglycol cyclohexane-1,2,3-tricarboxylate, diglycol cyclohexane-1,2,3-tricarboxylate, di-n-octyl cyclohexane-1,2,3-tricarboxylate, diisooctyl cyclohexane-1,2,3-tricarboxylate, di-2-ethylhexyl cyclohexane-1,2,3-tricarboxylate, di-n-nonyl cyclohexane-1,2,3-tricarboxylate, diisononyl cyclohexane-1,2,3-tricarboxylate, di-n-decyl cyclohexane-1,2,3-tricarboxylate, diisodecyl cyclohexane-1,2,3-tricarboxylate, di-n-undecyl cyclohexane-1,2,3-tricarboxylate, diisododecyl cyclohexane-1,2,3-tricarboxylate, di-n-octadecyl cyclohexane-1,2,3-tricarboxylate, diisooctadecyl cyclohexane-1,2,3-tricarboxylate, di-n-eicosyl cyclohexane-1,2,3-tricarboxylate, monocyclohexyl cyclohexane-1,2,3-tricarboxylate, dicyclohexyl cyclohexane-1,2,3-tricarboxylate, and trimethyl cyclohexane-1,2,3-tricarboxylate, triethyl cyclohexane-1,2,3-tricarboxylate, tri-n-propyl cyclohexane-1,2,3-tricarboxylate, tri-n-butyl cyclohexane-1,2,3-tricarboxylate, tri-tert-butyl cyclohexane-1,2,3-tricarboxylate, triisobutyl cyclohexane-1,2,3-tricarboxylate, triglycol cyclohexane-1,2,3-tricarboxylate, tri-n-octyl cyclohexane-1,2,3-tricarboxylate, triisooctyl cyclohexane-1,2,3-tricarboxylate, tri-2-ethyl cyclohexane-1,2,3-tricarboxylate, tri-n-nonyl cyclohexane-1,2,3-tricarboxylate, triisononyl cyclohexane-1,2,3-tricarboxylate, tri-n-decyl cyclohexane-1,2,3-tricarboxylate, triisododecyl cyclohexane-1,2,3-tricarboxylate, tri-n-undecyl cyclohexane-1,2,3-tricarboxylate, triisododecyl cyclohexane-1,2,3-tricarboxylate, tri-n-octadecyl cyclohexane-1,2,3-tricarboxylate, triisooctadecyl cyclohexane-1,2,3-tricarboxylate, tri-n-eicosyl cyclohexane-1,2,3-tricarboxylate, tricyclohexyl cyclohexane-1,2,3-tricarboxylate, di-n-hexyl cyclohexane-1,2,3-tricarboxylate, diisohexyl cyclohexane-1,2,3-tricarboxylate, tri-n-hexyl cyclohexane-1,2,3-tricarboxylate, triisohexyl cyclohexane-1,2,3-tricarboxylate, di-n-heptyl cyclohexane-1,2,3-tricarboxylate, diisoheptyl cyclohexane-1,2,3-tricarboxylate, tri-n-heptyl cyclohexane-1,2,3-tricarboxylate, triisoheptyl cyclohexane-1,2,3-tricarboxylate, di-n-pentyl cyclohexane-1,2,3-tricarboxylate, diisopentyl cyclohexane-1,2,3-tricarboxylate, tri-n-pentyl cyclohexane-1,2,3-tricarboxylate, triisopentyl cyclohexane-1,2,3-tricarboxylate, di-n-tridecyl cyclohexane-1,2,3-tricarboxylate, diisotridecyl cyclohexane-1,2,3-tricarboxylate, tri-n-tridecyl cyclohexane-1,2,3-tricarboxylate, triisotridecyl cyclohexane-1,2,3-tricarboxylate, di-n-dodecyl cyclohexane-1,2,3-tricarboxylate, diisoundecyl cyclohexane-1,2,3-tricarboxylate, tri-n-dodecyl cyclohexane-1,2,3-tricarboxylate, triisoundecyl cyclohexane-1,2,3-tricarboxylate, triisopropyl cyclohexane-1,2,3-tricarboxylate;

alkyl cyclohexane-1,2,4,5-tetracarboxylates, such as, for example, monomethyl cyclohexane-1,2,4,5-tetracarboxylate, dimethyl cyclohexane-1,2,4,5-tetracarboxylate, diethyl cyclohexane-1,2,4,5-tetracarboxylate, di-n-propyl cyclohexane-1,2,4,5-tetracarboxylate, di-n-butyl cyclohexane-1,2,4,5-tetracarboxylate, di-tert-butyl cyclohexane-1,2,4,5-tetracarboxylate, diisobutyl cyclohexane-1,2,4,5-tetracarboxylate, monoglycol cyclohexane-1,2,4,5-tetracarboxylate, diglycol cyclohexane-1,2,4,5-tetracarboxylate, di-n-octyl cyclohexane-1,2,4,5-tetracarboxylate, diisooctyl cyclohexane-1,2,4,5-tetracarboxylate, di-2-ethylhexyl cyclohexane-1,2,4,5-tetracarboxylate, di-n-nonyl cyclohexane-1,2,4,5-tetracarboxylate, diisononyl cyclohexane-1,2,4,5-tetracarboxylate, di-n-decyl cyclohexane-1,2,4,5-tetracarboxylate, diisodecyl cyclohexane-1,2,4,5-tetracarboxylate, di-n-undecyl cyclohexane-1,2,4,5-tetracarboxylate, diisododecyl cyclohexane-1,2,4,5-tetracarboxylate, di-n-octadecyl cyclohexane-1,2,4,5-tetracarboxylate, diisooctadecyl cyclohexane-1,2,4,5-tetracarboxylate, di-n-eicosyl cyclohexane-1,2,4,5-tetracarboxylate, monocyclohexyl cyclohexane-1,2,4,5-tetracarboxylate, trimethyl cyclohexane-1,2,4,5-tetracarboxylate, triethyl cyclohexane-1,2,4,5-tetracarboxylate, tri-n-propyl cyclohexane-1,2,4,5-tetracarboxylate, tri-n-butyl cyclohexane-1,2,4,5-tetracarboxylate, tri-tert-butyl cyclohexane-1,2,4,5-tetracarboxylate, triisobutyl cyclohexane-1,2,4,5-tetracarboxylate, triglycol cyclohexane-1,2,4,5-tetracarboxylate, tri-n-octyl cyclohexane-1,2,4,5-tetracarboxylate, triisooctyl cyclohexane-1,2,4,5-tetracarboxylate, tri-2-ethylhexyl cyclohexane-1,2,4,5-tetracarboxylate, tri-n-nonyl cyclohexane-1,2,4,5-tetracarboxylate, triisononyl cyclohexane-1,2,4,5-tetracarboxylate, tri-n-decyl cyclohexane-1,2,4,5-tetracarboxylate, triisododecyl cyclohexane-1,2,4,5-tetracarboxylate, tri-n-undecyl cyclohexane-1,2,4,5-tetracarboxylate, triisododecyl cyclohexane-1,2,4,5-tetracarboxylate, tri-n-octadecyl cyclohexane-1,2,4,5-tetracarboxylate, triisooctadecyl cyclohexane-1,2,4,5-tetracarboxylate, tri-n-eicosyl cyclohexane-1,2,4,5-tetracarboxylate, tricyclohexyl cyclohexane-1,2,4,5-tetracarboxylate, and tetramethyl cyclohexane-1,2,4,5-tetracarboxylate, tetraethyl cyclohexane-1,2,4,5-tetracarboxylate, tetra-n-propyl cyclohexane-1,2,4,5-tetracarboxylate, tetra-n-butyl cyclohexane-1,2,4,5-tetracarboxylate, tetra-tert-butyl cyclohexane-1,2,4,5-tetracarboxylate, tetraisobutyl cyclohexane-1,2,4,5-tetracarboxylate, tetraglycol cyclohexane-1,2,4,5-tetracarboxylate, tetra-n-octyl cyclohexane-1,2,4,5-tetracarboxylate, tetraisooctyl cyclohexane-1,2,4,5-tetracarboxylate, tetra-2-ethylhexyl cyclohexane-1,2,4,5-tetracarboxylate, tetra-n-nonyl cyclohexane-1,2,4,5-tetracarboxylate, tetraisononyl cyclohexane-1,2,4,5-tetracarboxylate, tetra-n-decyl cyclohexane-1,2,4,5-tetracarboxylate, tetraisodecyl cyclohexane-1,2,4,5-tetracarboxylate, tetraisododecyl cyclohexane-1,2,4,5-tetracarboxylate, tetra-n-undecyl cyclohexane-1,2,4,5-tetracarboxylate, tetra-n-octadecyl cyclohexane-1,2,4,5-tetracarboxylate, tetraisooctadecyl cyclohexane-1,2,4,5-tetracarboxylate, tetra-n-eicosyl cyclohexane-1,2,4,5-tetracarboxylate, tetracyclohexyl cyclohexane-1,2,4,5-tetracarboxylate, di-n-hexyl cyclohexane-1,2,4,5-tetracarboxylate, diisohexyl cyclohexane-1,2,4,5-tetracarboxylate, tri-n-hexyl cyclohexane-1,2,4,5-tetracarboxylate, triisohexyl cyclohexane-1,2,4,5-tetracarboxylate, di-n-heptyl cyclohexane-1,2,4,5-tetracarboxylate, diisoheptyl cyclohexane-1,2,4,5-tetracarboxylate, tri-n-heptyl cyclohexane-1,2,4,5-tetracarboxylate, triisoheptyl cyclohexane-1,2,4,5-tetracarboxylate, di-n-pentyl cyclohexane-1,2,4,5-tetracarboxylate, diisopentyl cyclohexane-1,2,4,5-tetracarboxylate, tri-n-pentyl cyclohexane-1,2,4,5-tetracarboxylate, triisopentyl cyclohexane-1,2,4,5-tetracarboxylate, di-n-tridecyl cyclohexane-1,2,4,5-tetracarboxylate, diisotridecyl cyclohexane-1,2,4,5-tetracarboxylate, tri-n-tridecyl cyclohexane-1,2,4,5-tetracarboxylate, triisotridecyl cyclohexane-1,2,4,5-tetracarboxylate, di-n-dodecyl cyclohexane-1,2,4,5-tetracarboxylate, diisoundecyl cyclohexane-1,2,4,5-tetracarboxylate, tri-n-dodecyl cyclohexane-1,2,4,5-tetracarboxylate, triisoundecyl cyclohexane-1,2,4,5-tetracarboxylate, triisopropyl cyclohexane-1,2,4,5-tetracarboxylate, tetra-n-hexyl cyclohexane-1,2,4,5-tetracarboxylate, tetraisohexyl cyclohexane-1,2,4,5-tetracarboxylate, tetra-n-heptyl cyclohexane-1,2,4,5-tetracarboxylate, tetraisoheptyl cyclohexane-1,2,4,5-tetracarboxylate, tetra-n-pentyl cyclohexane-1,2,4,5-tetracarboxylate, tetraisopentyl cyclohexane-1,2,4,5-tetracarboxylate, tetra-n-tridecyl cyclohexane-1,2,4,5-tetracarboxylate, tetraisotridecyl cyclohexane-1,2,4,5-tetracarboxylate, tetra-n-dodecyl cyclohexane-1,2,4,5-tetracarboxylate, tetraisoundecyl cyclohexane-1,2,4,5-tetracarboxylate, tetraisopropyl cyclohexane-1,2,4,5-tetracarboxylate.

Anhydrides of cyclohexane-1,2-dicarboxylic acid, cyclohexane-1,2,4-tricarboxylic acid, cyclohexane-1,2,3-tricarboxylic acid and cyclohexane-1,2,4,5-tetracarboxylic acid.

In addition, the cyclohexane-1,2-dicarboxylic esters disclosed in WO 99/32427 and listed again below are also suitable in the context of the present invention:

mixed esters of cyclohexane-1,2-dicarboxylic acid with C₁- to C₁₃-alcohols; diisopentyl cyclohexane-1,2-dicarboxylate, obtainable by hydrogenation of diisopentyl phthalate having the Chemical Abstracts Registry Number (below: CAS No.) 84777-06-0;

diisoheptyl cyclohexane-1,2-dicarboxylate, obtainable by hydrogenation of diisoheptyl phthalate having the CAS No. 71888-89-6;

diisononyl cyclohexane-1,2-dicarboxylate, obtainable by hydrogenation of a diisononyl phthalate having the CAS No. 68515-48-0;

diisononyl cyclohexane-1,2-dicarboxylate, obtainable by hydrogenation of a diisononyl phthalate having the CAS No. 28553-12-0, based on n-butene;

diisononyl cyclohexane-1,2-dicarboxylate, obtainable by hydrogenation of a diisononyl phthalate having the CAS No. 28553-12-0, based on isobutene;

a 1,2-di-C₉-ester of cyclohexanedicarboxylic acid, obtainable by hydrogenation of a dinonyl phthalate having the CAS No. 68515-46-8;

a diisodecyl cyclohexane-1,2-dicarboxylate, obtainable by hydrogenation of a diisodecyl phthalate having the CAS No. 68515-49-1;

a 1,2-di-C₇₋₁₁-ester of cyclohexanedicarboxylic acid, obtainable by hydrogenation of the corresponding phthalic ester having the CAS No. 68515-42-4;

a 1,2-di-C₇₋₁₁-ester of cyclohexanedicarboxylic acid, obtainable by hydrogenation of the di-C₇₋₁₁-phthalates having the following CAS No.

111 381-89-6,

111 381 90-9,

111 381 91-0,

68515-44-6,

68515-45-7 and

3648-20-2;

a 1,2-di-C₉₋₁₁-ester of cyclohexanedicarboxylic acid, obtainable by hydrogenation of a di-C₉₋₁₁-phthalate having the CAS No. 98515-43-6;

a diisodecyl cyclohexane-1,2-dicarboxylate, obtainable by hydrogenation of a diisodecyl phthalate which mainly comprises di(2-propylheptyl)phthalate;

a 1,2-di-C₇₋₉-cyclohexanedicarboxylic ester, obtainable by hydrogenation of the corresponding phthalic ester which has branched or linear C₇₋₉-alkyl ester groups; corresponding phthalates which can for example be used as starting materials have the following CAS No.:

di-C_{7,9}-alkyl phthalate having the CAS No. 111 381-89-6;

di-C₇-alkyl phthalate having the CAS No. 68515-44-6; and

di-C₉-alkyl phthalate having the CAS No. 68515-45-7.

The content of WO 99/32427, which relates, inter alia, to these compounds listed above and the preparation of cyclohexanepolycarboxylic acids using specific catalysts having macropores, is completely incorporated into the present application by reference.

According to the invention, hydrogenation products of phthalic acid mixed esters with C₁₀- and C₁₃-alcohols can also be used, as described in DE-A 100 32 580.7.

Furthermore, the hydrogenation products of the commercially available benzenecarboxylic esters having the trade names Jayflex DINP (CAS No. 68515-48-0), Jayflex DIDP (CAS No. 68515-49-1), Palatinol 9-P, Vestinol 9 (CAS No. 28553-12-0), TOTM-I (CAS No. 3319-31-1), Linplast 68-TM, Palatinol N (CAS No. 28553-12-0), Jayflex DHP (CAS No. 68515-50-4), Jayflex DIOP (CAS No. 27554-26-3), Jayflex UDP (CAS No. 68515-47-9), Jayflex DIUP (CAS No. 85507-79-5), Jayflex DTDP (CAS No. 68515-47-9), Jayflex L9P (CAS No. 68515-45-7), Jayflex L911P (CAS No. 68515-43-5), Jayflex L11P (CAS No. 3648-20-2), Witamol 110 (CAS No. 90193-91-2), Witamol 118 (di-n-C₈-C₁₀-alkylphthalate), Unimoll BB (CAS No. 85-68-7), Linplast 1012 BP (CAS No. 90193-92-3), Linplast 13 XP (CAS No. 27253-26-5), Linplast 610 P (CAS No. 68515-51-5), Linplast 68 FP (CAS No. 68648-93-1) and Linplast 812 HP (CAS No. 70693-30-0), Palatinol AH (CAS No. 117-81-7), Palatinol 711 (CAS No. 68515-42-4), Palatinol 911 (CAS No. 68515-43-5), Palatinol 11 (CAS No. 3648-20-2), Palatinol Z (CAS No. 26761-40-0) and Palatinol DIPP (CAS No. 84777-06-0) are also to be considered as being suitable in the context of the present invention.

Particularly preferred adhesives and sealants comprise dialkyl esters of 1,2-cyclohexanedicarboxylic acid. Straight-chain or branched alkyl groups having 1 to 13 C atoms or mixtures of said alkyl groups are preferred as ester group R. Straight-chain or branched alkyl groups having 8 to 10 C atoms or mixtures of said alkyl groups are particularly preferred as ester group R. Alkyl groups having 9 C atoms are very particularly preferred as ester group R.

The cyclohexanepolycarboxylic acid derivatives according to the invention are distinguished from the plasticizers known from the prior art and intended for adhesives and sealants by comparable or better performance characteristics. Thus, the adhesives and sealants prepared possess, in particular, better extensibility. As a result of this, the adhesives and sealants according to the invention are suitable for a multiplicity of applications which require rapid curing and impose exacting requirements on the extensibility, in conjunction with exacting requirements on tensile strength and adhesion properties.

The preparation of the cyclohexanepolycarboxylic acid derivatives is preferably effected according to the process disclosed in WO 99/32427. This process comprises the hydrogenation of a benzenepolycarboxylic acid or of a derivative thereof or of a mixture of two or more thereof by bringing the benzenepolycarboxylic acid or the derivative thereof or the mixture of two or more thereof into contact with a gas comprising hydrogen in the presence of a catalyst which comprises, as active metal, at least one metal of subgroup VIII of the Periodic Table of the Elements, alone or together with at least one metal of subgroup I or VII of the Periodic Table of the Elements, applied to a support, the support having macropores.

In a preferred embodiment, the support has a mean pore diameter of at least 50 nm and a BET surface area of not more than 30 m²/g and the amount of the active metal is 0,01 to 30% by weight, based on the total weight of the catalyst.

In a further embodiment, a catalyst is used in which the amount of the active metal is 0.01 to 30% by weight, based on the total weight of the catalyst, and 10 to 50% of the pore volume of the support is formed by macropores having a pore diameter in the range of 50 nm to 10 000 nm and 50 to 90% of the pore volume of the support is formed by mesopores having a pore diameter in the range of 2 to 50 nm, the sum of the proportions of pore volumes being 100%.

In a further embodiment, the catalyst has 0.01 to 30% by weight, based on the total weight of the catalyst, of an active metal, applied to a support, the support having a mean pore diameter of at least 0.1 μm and a BET surface area of not more than 15 m²/g. Supports which may be used are in principle all supports which have macropores, i.e. supports which have exclusively macropores and those which also comprise mesopores and/or micropores in addition to macropores.

In principle, all metals of subgroup VIII of the Periodic Table of the Elements can be used as active metal. Platinum, rhodium, palladium, cobalt, nickel or ruthenium or a mixture of two or more thereof is preferably used as active metals, in particular ruthenium being used as active metal. Among the metals of subgroup I or VII or of subgroup I and VII of the Periodic Table of the Elements, all of which can in principle likewise be used, copper and/or rhenium are preferably employed.

In the context of the present application, the terms “macropores” and “mesopores” are used in the manner defined in Pure Appl. Chem., 45, page 79 (1976), namely as pores whose diameter is above 50 nm (macropores) or whose diameter is between 2 nm and 50 nm (mesopores).

The content of the active metal is in general 0.01 to 30% by weight, preferably 0.01 to 5% by weight, particularly preferably 0.1 to 5% by weight, based in each case on the total weight of the catalyst used.

The term “benzenepolycarboxylic acid or a derivative thereof' which is used comprises all benzenepolycarboxylic acids per se, for example, phthalic acid, isophthalic acid, terephthalic acid, trimellitic acid, trimesic acid, hemimellitic acid and pyromellitic acid and derivatives thereof, mono-, di-, tri- and tetraesters, in particular alkyl esters, and anhydrides being mentioned in particular. The alkyl esters of said acids are preferred, the alkyl group preferably being a radical R which was defined above.

The preferably used alkyl benzenepolycarboxylates are generally prepared by reacting benzenepolycarboxylic acids with the alcohols corresponding to the alkyl groups of the esters. Suitable reaction conditions for the reaction of the benzenepolycarboxylic acids with the corresponding alcohols are known to the person skilled in the art.

In addition to the cyclohexanepolycarboxylic acid derivatives described and cyclohexanepolycarboxylic acid derivative mixtures obtainable by the process according to the invention, isoalkane mixtures which have a very high proportion of alkanes of the same molecular weight are also suitable for application in adhesives and sealants. These include cyclohexanepolycarboxylic acid derivative mixtures which have greater than or equal to 95% by weight, preferably at least 96% by weight, in particular at least 97% by weight, of cyclohexanepolycarboxylic acid derivatives of the same molecular weight.

A further subject of the present specification is an adhesive or sealant comprising at least (A) one compound selected from the group consisting of silylated polyurethanes, silylated polyureas, silylated polyethers, silylated polysulfides and silyl-terminated acrylates, and (B) one cyclohexanepolycarboxylic acid derivative, component (B) being preparable by the following process
a) esterification of a benzenepolycarboxylic acid of the formula II

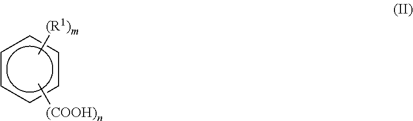

in which

R¹ denotes C₁-C₁₀-alkyl or C₃-C₈-cycloalkyl,

m denotes 0, 1, 2 or 3, and

n denotes 2, 3 or 4,

with one or more alcohols of the formula

R—OH

in which
R denotes C₁-C₃₀-alkyl, preferably C₁-C₂₀-alkyl, particularly preferably C₁-C₁₈-alkyl, very particularly preferably C₁-C₁₃-alkyl,

a benzenepolycarboxylic ester of the formula III

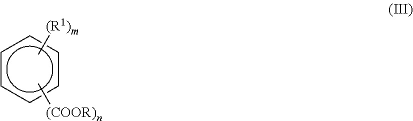

being obtained,
b) hydrogenation of the benzenepolycarboxylic ester of the formula III to give a corresponding cyclohexanepolycarboxylic ester.

Preferred embodiments of R¹, m, n and R are mentioned above with regard to the cyclohexanepolycarboxylic esters according to formula I.

A preferred embodiment of the hydrogenation of the benzenepolycarboxylic ester of the formula III (step b)) is mentioned above.

Preferably used benzenepolycarboxylic acids are phthalic acid, isophthalic acid, terephthalic acid, trimellitic acid, trimesic acid, hemimellitic acid and pyromellitic acid. Phthalic acid is very particularly preferably used. The abovementioned acids are commercially available.

Preferably used alcohols are the alcohols corresponding to the radicals R of the cyclohexanepolycarboxylic acid derivatives of the formula I. Linear or branched alcohols having C₁-C₁₃-alkyl radicals are therefore preferably used. The alcohols used for the esterification with the benzenepolycarboxylic acids may be in each case the individual isomers of the alcohols, which isomers correspond to the abovementioned radicals R, or may be mixtures of different alcohols having isomeric alkyl radicals with the same number of carbon atoms and/or may be mixtures of different alcohols having different numbers of carbon atoms.

The alcohols or alcohol mixtures suitable for the reaction with the benzenepolycarboxylic acids can be prepared by all processes known to the person skilled in the art. Suitable processes for the preparation of alcohols or process steps which are used in the preparation of alcohols are, for example:
hydroformylation with subsequent hydrogenation of the resulting aldehydes, for example as disclosed in WO 92/13818, DE-A 2 009 505, DE-A 199 24 339, EP-A 1 113 034, WO 00/63151, WO 99/25668, JP-A 1 160 928, JP-A 03 083 935, JP-A 2000/053803, EP-A 0 278 407, EP-A 1 178 029, FR-A 1 304 144, JP-A 30 44 340, JP-A 30 44 341, JP-A 30 44 342, JP-A 0 40 36 251, GB-A 721,540, DE-A 195 304 14, JP-A 2001/049029, U.S. Pat. No. 2,781,396, U.S. Pat. No. 3,094,564, FR-A 1 324 873, JP-A 0 816 9854, U.S. Pat. No. 3,153,673, U.S. Pat. No. 3,127,451, U.S. Pat. No. 1,828,344, WO 2003/66642, WO 2003/18912, EP-A 0 424 767, WO 2002/68369, EP-A 0 366 089, JP-A 2001/002829, DE-A 100 35 617, DE-A 199 55 593, WO 2002/00580, EP-A 0 643 031, U.S. Pat. No. 2,876,264, JP-A 2000/319444 and DE-A 100 32 580;
hydrogenation of aldol products, for example as disclosed in DE-A 102 51 311, JP-A 05 194 761, U.S. Pat. No. 3,272,873, DE-A 3 151 086, JP-A 2001/322959, WO 98/03462 and EP-A 0 603 630;
hydration of alkenes, for example as disclosed in U.S. Pat. No. 5,136,108, EP-A 0 325 144, EP-A 0 325 143, DE-A 100 50 627, U.S. Pat. No. 4,982,022, GB-A 2,187,741, DE-A 36 28 008, U.S. Pat. No. 3,277,191, JP-A 2000/191 566, DE-A 854 377, DE-A 38 01 275, DE-A 39 25 217, JP-A 06 321 828, JP-A 02 088 536, JP-A 06 287 156, JP-A 06 287 155, JP-A 54 141 712, JP-A 08 283 186, JP-A 09 263 558 and U.S. Pat. No. 4,684,751;
hydrogenation of carboxylic acids and carboxylic esters, in particular fatty acids and fatty acid esters, for example as disclosed in U.S. Pat. No. 5,463,143, U.S. Pat. No. 5,475,159, WO 94/10112, CA 2,314,690, WO 94/06738, JP-A 06 065 125 and U.S. Pat. No. 3,361,832;
hydrogenation of unsaturated alcohols or of carbonyl compounds, for example as disclosed in EP-A 0 394 842, DE-A 1 269 605, WO 88/05767, FR-A 1,595,013, EP-A 0 326 674, BE-A 756 877, BE-A 757 561, DE-A 1 277 232, FR-A 1,499,041 and DE-A 1 276 620;
hydrogenation of epoxides, for example as disclosed in FR-A 1,508,939, GB-A 879 803 and DE-A 1 078 106;
process comprising a telomerization step, for example as disclosed in EP-A 0 330 999, DE-A 1 138 751, U.S. Pat. No. 5,908,807, NE-6,603,884 and U.S. Pat. No. 3,091,628,
process comprising an isomerization step, for example as disclosed in DE-A 42 28 887;
hydrolysis of sulfates, for example as disclosed in GB-A 1,165,309;
reaction of dienes with amines, for example as disclosed in DE-A 44 31 528;
enzymatic preparation of alcohols, for example as disclosed in WO 93/24644;
selective hydrogenation of dienes, for example as disclosed in U.S. Pat. No. 3,203,998, DE-A 21 41 186, GB-A 2,093,025, JP-A 02 129 24, JP-A 1 122 8468, DE-A 195 44 133, WO 94/00410, GB-A 2,260,136, DE-A 44 10 746 and JP-A 08 176 036;
preparation of alcohols from nitriles, for example as disclosed in EP-A 0 271 092;
preparation of alcohols by reaction of alkynes, for example as disclosed in RU 205 9597-C1; and
hydrogenolysis of substituted tetrahydropyrans, for example as disclosed in GB 1,320,188.

Further processes for the preparation of alcohols which can likewise be used for the preparation of alcohols or alcohol mixtures suitable for the esterification with benzenepolycarboxylic acids are known to the person skilled in the art. Preferably used alcohols are—as mentioned above—alcohols which have C₁-C₁₃-alkyl radicals. In particular, the relatively long-chain C₅-C₁₃-alcohols or alcohol mixtures which comprise these alcohols are particularly preferably prepared by catalytic hydroformylation (also referred to as oxoreaction) of olefins and subsequent hydrogenation of the aldehydes formed. Suitable hydroformylation processes are known to the person skilled in the art and are disclosed in the abovementioned documents. The alcohols and alcohol mixtures disclosed in said documents can be reacted with the abovementioned benzenepolycarboxylic acids to give the desired alkyl benzenepolycarboxylates or mixtures of alkyl benzenepolycarboxylates.

C₅-Alcohols or mixtures which comprise C₅-alcohols, particularly preferably n-pentanol, can be prepared, for example, by hydroformylation of butadiene in the presence of an aqueous solution of a rhodium compound and of a phosphine as a catalyst. Such a process is disclosed, for example, in EP-A 0 643 031.

Suitable C₇-alcohol mixtures which can be used for the esterification with the benzenepolycarboxylic acids are disclosed, for example, in JP-A 2000/319 444. The preparation of the C₇-alcohol mixture is effected by hydroformylation with subsequent hydrogenation of the aldehydes formed.

Mixtures comprising C₈-alcohols and their preparation processes are disclosed, for example, in GB-A 721 540, in which a process for the preparation of isooctyl alcohols starting from heptenes by means of hydroformylation and subsequent hydrogenation is described. Further documents which disclose the preparation of C₇-alcohols or mixtures comprising these alcohols are DE-A 195 30 414, JP-A 2001/49029, U.S. Pat. No. 2,781,396, U.S. Pat. No. 3,094,564, FR-A 1,324,873, JP-A 08 169 854, U.S. Pat. No. 3,153,673, U.S. Pat. No. 3,127,451 and U.S. Pat. No. 1,828,344.

C₉-Alcohols or mixtures comprising C₉-alcohols are preferably prepared by dimerization of butenes, hydroformylation of the octenes obtained and subsequent hydrogenation of the C₉-aldehyde obtained.

Suitable processes and mixtures comprising C₉-alcohols are disclosed, for example, in WO 92/13818, DE-A 20 09 505, DE-A 199 24 339, EP-A 1 113 034, WO 2000/63151, WO 99/25668, JP-A 1 160 928, JP-A 03 083 935, JP-A 2000/053803, EP-A 0 278 407 and EP-A 1 178 029.

C₁₀-Alcohols and mixtures comprising these alcohols are disclosed, for example, in WO 2003/66642, WO 2003/18912, EP-A 0 424 767, WO 2002/68369, EP-A 0 366 089 and JP-A 2001/002829.

C₁₂-Alcohols or mixtures comprising C₁₂-alcohols, in particular trimethylnonanol, and a process for the preparation thereof are disclosed, for example, in WO 98/03462.

C₁₃-Alcohols and mixtures comprising these alcohols are disclosed, for example, in DE-A 100 32 580, DE-A 199 55 593 and WO 2002/00580.

Particularly preferably, dialkyl esters of the abovementioned cyclohexanedicarboxylic acids, in particular 1,2-, 1,3- or 1,4-dialkyl esters and very particularly preferably 1,2-dialkyl esters, are used in the auxiliaries or as auxiliaries according to the present application. It is possible to use dialkyl esters in which both ester groups of the dialkyl esters carry the same alkyl radicals, and ester groups in which the two ester groups of the dialkyl esters carry different alkyl groups. Examples of mixed and non-mixed alkyl esters of the cyclohexanedicarboxylic acids have already been mentioned above. Furthermore, it is possible that the alkyl groups of the alkyl cyclohexanedicarboxylates have the same number of carbon atoms but are straight-chain or have different branches and hence form isomer mixtures. Such isomer mixtures can also be used if the number of carbon atoms of the alkyl groups of the dialkyl esters is different. The proportion of the different isomers of the alkyl groups arises in general from the composition of the alcohols which are used for the esterification of the benzenedicarboxylic acids, which are hydrogenated to give the cyclohexanedicarboxylic esters after esterification. Suitable alcohol mixtures have already been mentioned above. In the context of the present application, straight-chain or branched alkyl radicals having a certain number of carbon atoms are therefore to be understood as meaning not only the respective individual isomers but also isomer mixtures whose composition—as mentioned above—arises from the composition of the alcohols used for the esterification of the benzenedicarboxylic acids. In the context of the present application, straight-chain alkyl radicals are to be understood as meaning exclusively straight-chain alkyl radicals, but also mixtures of alkyl radicals which are predominantly straight-chain.

If the alkyl radicals R of the cyclohexanepolycarboxylic esters are C₁- to C₄-alkyl radicals, these are obtained by reaction of the benzenepolycarboxylic acids of the formula II with methanol, ethanol, n-propanol, isopropanol, n-butanol, isobutanol, sec-butanol or tert-butanol. In each case mixtures of said propanols or butanols or individual isomers can be used for the preparation of benzenepolycarboxylic esters in which R is 3 or 4. Individual isomers of propanol or of butanol are preferably used. The preparation of the abovementioned C₁- to C₄-alcohols is known to the person skilled in the art.

If the alkyl radicals R of the cyclohexanepolycarboxylic esters are C₅- to C₁₃-alkyl radicals, C₅- to C₁₃-alcohols are preferably used which have degrees of branching (ISO index) of in general 0.10 to 4, preferably 0.5 to 3, particularly preferably 0.8 to 2 and in particular 1 to 1.5, i.e. in general the respective alcohols are mixtures of different isomers. Very particularly preferably, C₉-alcohol mixtures having an ISO index of 1 to 1.5, in particular nonanol mixtures having an ISO index of 1.25 or 1.6, are used.

The ISO index is a dimension-less quantity which was determined by means of gas chromatography.
Method: Capillary GC
Apparatus: Capillary gas chromatograph with autosampler, split/splitless injection system and flame ionization detector (FID)
Chemicals: —MSTFA (N-methyl-N-trimethylsilyltrifluoroacetamide)
   Comparisons for determination of the retention times
Sample preparation: 3 drops of the sample are kept in 1 ml of MSTFA and for 60 minutes at 80° C.
GC conditions: Capillary column: Ultra-1
   Length: 50 m
   Internal diameter: 0.25 mm
   Film thickness: 0.1 micron
   Carrier gas: helium
   Column admission
      pressure: 200 psi constant
   Split: 80 ml/min
   Septum flushing: 3 ml/min
   Oven temperature: 120° C., 25 min isothermal
   Injector temperature: 250° C.
   Detector temperature: 250° C. (FID)
   Injection volume: 0.5 microliter
Calculation The procedure for the calculation of the ISO index is shown in the following table:

| Compo- | | | Proportion | |
|---|---|---|---|---|
| nent | Name | Branching | in area % | Index |
| 1 | 2-Ethyl-2-methylhexan-1-ol | 2 | 1.00 | 0.0200 |
| 2 | 2-Ethyl-4-methylhexan-1-ol | 2 | 1.00 | 0.0200 |
| 3 | 2-Ethyl-4-methylhexan-1-ol | 2 | 1.00 | 0.0200 |
| 4 | 2-Propyl-3-methylpentan-1-ol | 2 | 1.00 | 0.0200 |
| 5 | 2-Propyl-hexan-1-ol | 1 | 1.00 | 0.0100 |
| 6 | 2,5-Dimethylheptan-1-ol | 2 | 1.00 | 0.0200 |
| 7 | 2,3-Dimethylheptan-1-ol | 2 | 1.00 | 0.0200 |
| 8 | 2,3,4-Trimethylhexan-1-ol | 3 | 1.00 | 0.0300 |
| 9 | 2-Ethylheptan-1-ol | 1 | 1.00 | 0.0100 |
| 10 | 3-Ethyl-4-methylhexan-1-ol | 2 | 82.00 | 1.6400 |
| 11 | 3-Ethylheptan-1-ol | 1 | 1.00 | 0.0100 |
| 12 | 2-Methyloctan-1-ol | 1 | 1.00 | 0.0100 |
| 13 | 4,5-Dimethylheptan-1-ol | 2 | 1.00 | 0.0200 |
| 14 | 4,5-Dimethylheptan-1-ol | 2 | 1.00 | 0.0200 |
| 15 | 4-Methyloctan-1-ol | 1 | 1.00 | 0.0100 |
| 15a | 7-Methyloctan-1-ol | 1 | 1.00 | 0.0000 |
| 16 | 6-Methyloctan-1-ol | 1 | 1.00 | 0.0100 |
| 17 | Nonan-1-ol | 0 | 1.00 | 0.0000 |
| | | Total: | 99.00 | 1.9000 |
| | Unknown component | 2 | 1.00 | 0.0200 |
| | | | ISO index: | 1.9200 |

The C₅- to C₁₃-alcohols are prepared according to the abovementioned processes. For the preparation of cyclohexanepolycarboxylic esters in which R is 9, a nonanol mixture is particularly preferably used in which 0 to 20% by weight, preferably 0.5 to 18% by weight, particularly preferably 6 to 16% by weight, of the nonanol mixture has no branches, 5 to 90% by weight, preferably 10 to 80% by weight, particularly preferably 45 to 75% by weight, has one branch, 5 to 70% by weight, preferably 10 to 60% by weight, particularly preferably 15 to 35% by weight, has two branches, 0 to 10% by weight, preferably 0 to 8% by weight, particularly preferably 0 to 4% by weight, has three branches and 0 to 40% by weight, preferably 0.1 to 30% by weight, particularly preferably 0.5 to 6.5% by weight, is other components. Other components are to be. understood in general as meaning nonanols having more than three branches, decanols or octanols, the sum of said components being 100% by weight.

A particularly preferred embodiment of an isononanol mixutre which is employed for the preparation of inventively preferably used cyclohexanedicarboxylic acid isononyl esters has the following composition:
1.73 to 3.73% by weight, preferably 1.93 to 3.53% by weight, particularly preferably 2.23 to 3.23% by weight, of 3-ethyl-6-methylhexanol;
0.38 to 1.38% by weight, preferably 0.48 to 1.28% by weight, particularly preferably 0.58 to 1.18% by weight, of 2,6-dimethylheptanol;
2.78 to 4.78% by weight, preferably 2.98 to 4.58% by weight, particularly preferably 3.28 to 4.28% by weight, of 3,5-dimethylheptanol;
6.30 to 16.30% by weight, preferably 7.30 to 15.30% by weight, particularly preferably 8.30 to 14.30% by weight, of 3,6-dimethylheptanol;
5.74 to 11.74% by weight, preferably 6.24 to 11.24% by weight, particularly preferably 6.74 to 10.74% by weight, of 4,6-dimethylheptanol;
1.64 to 3.64% by weight, preferably 1.84 to 3.44% by weight, particularly preferably 2.14 to 3.14% by weight, of 3,4,5-trimethylhexanol;
1.47 to 5.47% by weight, preferably 1.97 to 4.97% by weight, particularly preferably 2.47 to 4.47% by weight, of 3,4,5-trimethylhexanol, 3-methyl-4-ethylhexanol and 3-ethyl-4-methylhexanol;
4.00 to 10.00% by weight, preferably 4.50 to 9.50% by weight, particularly preferably 5.00 to 9.00% by weight, of 3,4-dimethylheptanol;
0.99 to 2.99% by weight, preferably 1.19 to 2.79% by weight, particularly preferably 1.49 to 2.49% by weight, of 4-ethyl-5-methylhexanol and 3-ethylheptanol;
2.45 to 8.45% by weight, preferably 2.95 to 7.95% by weight, particularly preferably 3.45 to 7.45% by weight, of 4,5-dimethylheptanol and 3-methyloctanol;
1.21 to 5.21% by weight, preferably 1.71 to 4.71% by weight, particularly preferably 2.21 to 4.21% by weight, of 4,5-dimethylheptanol;
1.55 to 5.55% by weight, preferably 2.05 to 5.05% by weight, particularly preferably 2.55 to 4.55% by weight, of 5,6-dimethylheptanol;
1.63 to 3.63% by weight, preferably 1.83 to 3.43% by weight, particularly preferably 2.13 to 3.13% by weight, of 4-methyloctanol;
0.98 to 2.98% by weight, preferably 1.18 to 2.78% by weight, particularly preferably 1.48 to 2.48% by weight, of 5-methyloctanol;
0.70 to 2.70% by weight, preferably 0.90 to 2.50% by weight, particularly preferably 1.20 to 2.20% by weight, of 3,6,6-trimethylhexanol;
1.96 to 3.96% by weight, preferably 2.16 to 3.76% by weight, particularly preferably 2.46 to 3.46% by weight, of 7-methyloctanol;
1.24 to 3.24% by weight, preferably 1.44 to 3.04% by weight, particularly preferably 1.74 to 2.74% by weight, of 6-methyloctanol;
0.1 to 3% by weight, preferably 0.2 to 2% by weight, particularly preferably 0.3 to 1% by weight, of n-nonanol;
25 to 35% by weight, preferably 28 to 33% by weight, particularly preferably 29 to 32% by weight, of other alcohols having 9 and 10 carbon atoms; the total sum of said components being 100% by weight.

An isononanol mixture of this kind is present, esterified with phthalic acid, in the diisononyl phthalate of CAS No. 68515-48-0, from which the cyclohexane-1,2-dicarboxylic acid diisononyl ester with corresponding isononyl component can be generated by hydrogenating the aromatic nucleus. Isononanol mixtures of this kind may be obtained via the path of zeolite-catalyzed oligomerization of C₂-, C₃- and C₄-olefin mixtures, a process known as the Polygas process, recovering a C₈ fraction from the oligomer, and subjecting it subsequently to hydroformylation and hydrogenation.

A particularly preferred embodiment of an isononanol mixture which is employed for the preparation of inventively particularly preferably used cyclohexanedicarboxylic acid diisononyl esters has the following composition:
6.0 to 16.0% by weight, preferably 7.0 to 15.0% by weight, particularly preferably 8.0 to 14.0% by weight, of n-nonanol;
12.8 to 28.8% by weight, preferably 14.8 to 26.8% by weight, particularly preferably 15,8 to 25.8% by weight, of 6-methyloctanol;
12.5 to 28.8% by weight, preferably 14.5 to 26.5% by weight, particularly preferably 15.5 to 25.5% by weight, of 4-methyloctanol;
3.3 to 7.3% by weight, preferably 3.8 to 6.8% by weight, particularly preferably 4.3 to 6.3% by weight, of 2-methyloctanol;
5.7 to 11.7% by weight, preferably 6.3 to 11.3% by weight, particularly preferably 6.7 to 10.7% by weight, of 3-ethylheptanol;
1.9 to 3.9% by weight, preferably 2.1 to 3.7% by weight, particularly preferably 2.4 to 3.4% by weight, of 2-ethylheptanol;
1.7 to 3.7% by weight, preferably 1.9 to 3.5% by weight, particularly preferably 2.2 to 3.2% by weight, of 2-propylhexanol;
3.2 to 9.2% by weight, preferably 3.7 to 8.7% by weight, particularly preferably 4.2 to 8.2% by weight, of 3,5-dimethylheptanol;
6.0 to 16.0% by weight, preferably 7.0 to 15.0% by weight, particularly preferably 8.0 to 14.0% by weight, of 2,5-dimethylheptanol;
1.8 to 3.8% by weight, preferably 2.0 to 3.6% by weight, particularly preferably 2.3 to 3.3% by weight, of 2,3-dimethylheptanol;
0.6 to 2.6% by weight, preferably 0.8 to 2.4% by weight, particularly preferably 1.1 to 2.1% by weight, of 3-ethyl-4-methylhexanol;
2.0 to 4.0% by weight, preferably 2.2 to 3.8% by weight, particularly preferably 2.5 to 3.5% by weight, of 2-ethyl-4-methylhexanol;
0.5 to 6.5% by weight, preferably 1.5 to 6% by weight, particularly preferably 1.5 to 5.5% by weight, of other alcohols having 9 carbon atoms;
the total sum of said components being 100% by weight.

An isononanol mixture of this kind is present, esterified with phthalic acid, in the diisononyl phthalate of CAS No. 28553-12-0, from which the cyclohexane-1,2-dicarboxylic acid diisononyl ester with corresponding isononyl component can be generated by hydrogenation of the aromatic nucleus, as for example by the method of WO 99/32427. Isononanol mixtures of this kind can be obtained via the path of the dimerization of predominantly n-butenes to octene mixtures by means of nickel-containing catalysts, as for example by the method of WO 95/14647, subsequent hydroformylation of the resultant octene mixture, preferably cobalt-catalyzed hydroformylation, and hydrogenation. One cyclohexane-1,2-dicarboxylic acid diisononyl ester prepared by this path is on the market under name Hexamoll® DINCH.

The silylated polyurethanes, silylated polyureas, silylated polyethers, silylated polysulfides and silyl-terminated acrylates that are used as component (A) are known to the person skilled in the art, with virtually all polymers from these classes that are known in accordance with the prior art being suitable in the context of the present invention.

The silylated polyurethanes and silylated polyureas are composed of at least one polyol and/or polyamine component, of at least one polyisocyanate component and of at least one silylating agent component.

In one preferred embodiment of the invention, the molar ratio of the isocyanate component present in the polymer to the sum of the polyol and/or polyamine component is 0.01 to 50, preferably 0.5 to 1.8. It is additionally considered preferred for at least 30%, more particularly at least 80%, more preferably at least 95%, of the reactive end groups in the polyurethane polymer and/or polyurea polymer to have been reacted with the silylating agent.

The isocyanate component is preferably an aliphatic, cycloaliphatic, araliphatic and/or aromatic compound, preferably a diisocyanate or triisocyanate, and may also comprise mixtures of these compounds. It is regarded here as being preferred for it to be hexamethylene 1,6-diisocyanate (HDI), HDI dimer, HDI trimer, 1-isocyanato-3,3,5-trimethyl-5-isocyanatomethylcyclohexane (IPDI), 2,4- and/or 2,6-tolylene diisocyanate (TDI) and/or 4,4′-, 2,4′- and/or 2,2′-diphenylmethane diisocyanate (MDI), polymeric MDI, carbodiimide-modified 4,4′-MDI, m-xylene diisocyanate (MXDI), m- or p-tetramethylxylene diisocyanate (m-TMXDI, p-TMXDI), 4,4′-dicyclohexylmethane diisocyanate (H12MDI), naphthalene-1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI) and 1,12-dodecane diisocyanate (C12DI).

The polyol and/or polyamine component preferably comprises polyetherester polyol, polyether polyols, polyester polyols, polybutadiene polyols and polycarbonate polyols, and may also comprise mixtures of these compounds. The polyols and/or polyamines comprise preferably between two and 10, more preferably between two and three hydroxyl groups and/or amino groups, and possess a weight-average molecular weight of between 32 and 30 000, more preferably between 90 and 18 000 g/mol. Suitable polyols are preferably the polyhydroxy compounds that at room temperature are liquids, glasslike-solid/amorphous compounds or crystalline compounds. Typical examples might include difunctional polypropylene glycols. It is also possible for hydroxyl-containing random copolymers and/or block copolymers of ethylene oxide and propylene oxide to be used. Suitable polyether polyols are the polyethers known per se in polyurethane chemistry, such as the polyols prepared, using starter molecules, by means of KOH catalysis or DMC catalysis, from styrene oxide, ethylene oxide, propylene oxide, butylene oxide, tetrahydrofuran or epichlorohydrin.

Specific suitability is also possessed more particularly by poly(oxytetramethylene) glycol (polyTHF), 1,2-polybutylene glycol, or mixtures thereof. Particular suitability is possessed by polypropylene oxide, polyethylene oxide and butylene oxide and mixtures thereof. Another type of copolymer which can be used as a polyol component and which terminally contains hydroxyl groups is in accordance with the following general formula (and can be prepared, for example, by means of “controlled” high-speed anionic polymerization according to Macromolecules 2004, 37, 4038-4043):

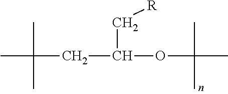

in which R is alike or different and is represented preferably by OMe, OiPr, Cl or Br.

Additionally suitable as a polyol component are, more particularly, the polyester diols and polyester polyols which at 25° C. are liquid, glasslike-amorphous or crystalline compounds and which are preparable by condensation of dicarboxylic or tricarboxylic acids, such as adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid and/or dimer fatty acid, with low molecular mass diols, triols or polyols, such as ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol, pentaerythritol and/or trimethylolpropane.

A further suitable group of polyols are the polyesters based, for example, on caprolactone, which are also referred to as “polycaprolactones”. Other polyols which can be used are polycarbonate polyols and dimerdiols, and also polyols based on vegetable oils and their derivatives, such as castor oil and its derivatives or epoxidized soybean oil. Also suitable are polycarbonates containing hydroxyl groups, which are obtainable by reacting derivatives of carbonic acid, e.g. diphenyl carbonate, dimethyl carbonate or phosgene, with diols. Particular suitability is possessed for example by ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethylpentane-1,3-diol, dipropylene glycol, polypropylene glycols, dibutylene glycol, polybutylene glycols, bisphenol A, tetrabromobisphenol A, glycerol, trimethylolpropane, 1,2,6-hexanetriol, 1,2,4-butanetriol, trimethylolpropane, pentaerythritol, quinitol, mannitol, sorbitol, methylglycoside and 1,3,4,6-dianhydrohexitols. The hydroxy-functional polybutadienes as well, which are purchasable under trade names including that of “Poly-bd®”, can be used as a polyol component, as can their hydrogenated analogs. Additionally suitable are hydroxy-functional polysulfides, which are sold under the trade name “Thiokol® NPS-282”, and also hydroxy-functional polysiloxanes.

Particular suitability as a polyamine component which can be used in accordance with the invention is possessed by hydrazine, hydrazine hydrate and substituted hydrazines, such as N-methylhydrazine, N,N′-dimethylhydrazine, acid hydrazides of adipic acid, methyladipic acid, sebacic acid, hydracrylic acid, terephthalic acid, isophthalic acid, semicarbazidoalkylene hydrazides, such as 13-semicarbazidopropionyl hydrazide, semicarbazidoalkylene-carbazine esters, such as, for example, 2-semicarbazidoethyl-carbazine ester and/or aminosemicarbazide compounds, such as 13-aminoethyl semicarbazidocarbonate.

Polyamines, for example those sold under the trade name of Jeffamine® (which are polyether polyamines), are also suitable.

As polyol component and/or polyamine component, suitability is also possessed by the species which are known as chain extenders and which, in the preparation of polyurethanes and polyureas, react with excess isocyanate groups; they normally have a molecular weight (Mn) of below 400 and are frequently present in the form of polyols, aminopolyols or aliphatic, cycloaliphatic or araliphatic polyamines.

Examples of suitable chain extenders are as follows:
alkanediols, such as ethanediol, 1,2- and 1,3-propanediol, 1,4- and 2,3-butanediol, 1,5-pentanediol, 1,3-dimethylpropanediol, 1,6-hexanediol, neopentyl glycol, cyclohexanedimethanol, 2-methyl-1,3-propanediol, hexylene glycol, 2,5-dimethyl-2,5-hexanediol
ether diols, such as diethylene diglycol, triethylene glycol or hydroquinone dihydroxyethyl ether
hydroxybutyl hydroxycaproic esters, hydroxyhexyl hydroxybutyric esters, adipic acid hydroxyethyl esters and terephthalic bishydroxyethyl esters, and
polyamines, such as ethylenediamine, 1,2- and 1,3-diaminopropane, 1,4-diaminobutane, 1,6-diaminohexane, isomer mixture of 2,2,4- and 2,4,4-trimethyl-hexamethylenediamine, 2-methylpentamethylenediamine, diethylenetriamine, 1,3- and 1,4-xylylenediamine and 4,4-diaminodicyclohexylmethane

Lastly it should be mentioned that the polyol component and/or polyamine component may comprise double bonds, which may result, for example, from long-chain aliphatic carboxylic acids or fatty alcohols. Functionalization with olefinic double bonds is also possible, for example, through the incorporation of vinylic and/or allylic groups. These may for example originate from unsaturated acids such as maleic anhydride, acrylic acid or methacrylic acid and their respective esters.

For the purposes of the invention it is particularly preferred for the polyol component and/or polyamine component to be polypropylene diol, polypropylene triol, polypropylene polyol, polyethylene diol, polyethylene triol, polyethylene polyol, polypropylenediamine, polypropylenetriamine, polypropylenepolyamine, poly-THF-diamine, polybutadiene diol, polyester diol, polyester triol, polyester polyol, polyesterether diol, polyesterether triol, polyesterether polyol, more preferably polypropylene diol, polypropylene triol, polyTHF diol, polyhexanediol carbamate diol, polycaprolactamdiol and polycaprolactamtriol. It is also possible for these components to be mixtures of the stated compounds.

As far as the silylating component present is concerned, suitability is possessed by
1. primary and/or secondary aminosilanes; α or γ position
   e.g. H₂N—CH₂—Si(OR²)₃
      H₂N—(CH₂)₃—Si(OR²)₃
      R′NH—(CH₂)₃—Si(OR²)₃
      R′NH—CH₂—CHMe-CH₂—Si(OR²)₃
   where OR² independently of one another is represented by an alkoxy group, with R² being an alkyl group having one to 5 carbon atoms, e.g. methyl, ethyl, isopropyl, n-propyl, n-butyl, isobutyl, sec-butyl, and/or OR² is a phenoxy group, a naphthyloxy group, a phenoxy group which is substituted in the ortho-, meta- and/or para-position, with a C₁-C₂₀ alkyl, alkylaryl, alkoxy, phenyl, substituted phenyl, thioalkyl, nitro, halogen, nitrile, carboxyalkyl, carboxyamide, —NH₂ and/or NHR group, in which R is a linear, branched or cyclic C₁-C₂₀ alkyl group, e.g. methyl, ethyl, propyl (n, iso), butyl (n, iso, sec) or cyclohexyl or phenyl, with R′ being a linear, branched or cyclic C₁-C₂₀ alkyl group, e.g. methyl, ethyl, propyl (n, iso), butyl (n, iso, sec) or cyclohexyl or phenyl,
2. isocyanatosilanes; α or γ position
3. products obtained by Michael addition of primary aminosilanes in α- and γ-position and ring closure to form the hydantoin, e.g. U.S. Pat. No. 5,364,955.

With regard to the silylating component present, reference is made to patent applications WO 2006/088839 A2 and WO 2008/061651 A1, and also to patent EP 1 685 171 B1, the content of which is hereby adopted into the present specification.

The silylating components which are present in the silylated polyurethane or in the silylated polyurea and which are preferred for the purposes of the present invention are more particularly silanes of the general formula:

Y—R¹—Si(Me)ₙ(OR²)₃₋ₙ

where Y is represented by —NCO, —NHR, —NH₂ or —SH,

R is represented by an alkyl group or aryl group having one to 20 carbon atoms, e.g. methyl, ethyl, isopropyl, n-propyl, butyl group (n-, iso-, sec-), cyclohexyl, phenyl and naphthyl,

R¹ is represented by a divalent hydrocarbon unit having one to 10 carbon atoms, e.g. ethylene, methylethylene,

Me is represented by methyl,

OR² independently of one another is represented by an alkoxy group, where R² is an alkyl group having one to 5 carbon atoms, e.g. methyl, ethyl, isopropyl, n-propyl, n-butyl, isobutyl, sec-butyl, and/or OR² is a phenoxy group, a naphthyloxy group, a phenoxy group, which is substituted at the ortho-, meta- and/or para-position, with a C₁-C₂₀ alkyl, alkylaryl, alkoxy, phenyl, substituted phenyl, thioalkyl, nitro, halogen, nitrile, carboxyalkyl, carboxyamide, —NH₂ and/or NHR group, in which R is a linear, branched or cyclic C₁-C₂₀ alkyl group, e.g. methyl, ethyl, propyl (n-, iso-), butyl (n-, iso-, sec-) or phenyl, and

n is represented by 0, 1, 2 or 3.

As silylating component it is also possible, however, for mixtures of at least two of the stated compounds to be present in the polymer.

In one preferred embodiment, silylating components of interest are more particularly alkoxysilanes comprising isocyanate groups or amino groups. Suitable alkoxysilanes comprising amino groups are more particularly compounds which are selected from the group consisting of 3-aminopropyltrimethoxysilane, 3-aminopropyltriethoxysilane, 3-aminopropylmethyldimethoxysilane, 3-aminopropylmethyldiethoxysilane, 3-amino-2-methylpropyltrimethoxysilane, 4-aminobutyltrimethoxysilane, 4-aminobutylmethyldimethoxysilane, 4-amino-3-methylbutyltrimethoxysilane, 4-amino-3,3-dimethylbutyltrimethoxysilane, 4-amino-3,3-dimethylbutyldimethoxymethylsilane, aminomethyltrimethoxysilane, aminomethyldimethoxymethylsilane, aminomethylmethoxydimethylsilane, aminomethyltriethoxysilane, aminomethyldiethoxymethylsilane, aminomethylethoxydimethylsilane, N-methyl-3-aminopropyltrimethoxysilane, N-methyl-3-aminopropyldimethoxymethylsilane, N-ethyl-3-aminopropyltrimethoxysilane, N-ethyl-3-aminopropyldimethoxymethylsilane, N-butyl-3-aminopropyltrimethoxysilane, N-butyl-3-aminopropyldimethoxymethylsilane, N-cyclohexyl-3-aminopropyltrimethoxysilane, N-cyclohexylaminomethyltriethoxysilane, cyclohexylaminomethyltrimethoxysilane, N-phenyl-3-aminopropyltrimethoxysilane, N-methyl-3-amino-2-methylpropyltrimethoxysilane, N-methyl-3-amino-2-methylpropyldimethoxymethylsilane, N-ethyl-3-amino-2-methylpropyltrimethoxysilane, N-ethyl-3-amino-2-methylpropyldimethoxymethylsilane, N-ethyl-3-aminopropyldimethoxymethylsilane, N-ethyl-3-aminopropyltrimethoxysilane, N-phenyl-4-aminobutyltrimethoxysilane, N-phenylaminomethyldimethoxymethylsilane, N-phenylaminomethyltrimethoxysilane, N-cyciohexylaminomethyldimethoxymethylsilane, N-cyclohexylaminomethyltrimethoxysilane, N-methylaminomethyldimethoxymethylsilane, N-methylaminomethyltrimethoxysilane, N-ethylaminomethyldimethoxymethylsilane, N-ethylaminomethyltrimethoxysilane, N-propylaminomethyldimethoxymethylsilane, N-propylaminomethyltrimethoxysilane, N-butylaminomethyldimethoxymethylsilane, N-butylaminomethyltrimethoxysilane, N-(2-aminoethyl)-3-aminopropyltrimethoxysilane, N-(2-aminoethyl)-3-aminopropylmethyldimethoxysilane, 3-[2-(2-aminoethylamino)ethylamino]propyltrimethoxysilane, bis(trimethoxysilylpropyl)amine, bis(dimethoxy(methyl)silylpropyl)amine, bis(trimethoxysilylmethyl)amine, bis(dimethoxy(methyl)silylmethyl)amine, 3-ureidopropyltrimethoxysilane, N-methyl[3-(trimethoxysilyl)propyl]carbamates, N-trimethoxysilylmethyl-O-methylcarbamate, N-dimethoxy(methyl)silylmethylcarbamate and the analogs thereof having ethoxy or isopropoxy groups or n-propoxy groups or n-butoxy groups or isobutoxy groups or sec-butoxy groups instead of the methoxy groups on the silicon.

Suitable alkoxysilanes comprising isocyanate groups are more particularly compounds which are selected from the group consisting of isocyanatopropyltriethoxysilane, isocyanatopropyltrimethoxysilane, isocyanatopropylmethyldiethoxysilane, isocyanatopropylmethyldimethoxysilane, isocyanatomethyltrimethoxysilane, isocyanatomethyltriethoxysilane, isocyanatomethylmethyldiethoxysilane, isocyanatomethylmethyldimethoxysilane, isocyanatomethyldimethylmethoxysilane or isocyanatomethyldimethylethoxysilane, and also their analogs having isopropoxy or n-propoxy groups.

With regard to the silylated polyurethanes for preferred use in accordance with the present invention, and to their preparation, reference is made, furthermore, to patent applications U.S. Pat. No. 3,632,557, U.S. Pat. No. 5,364,955, WO 01/16201, EP 931800, EP 1093482 B1, US 2004260037, US 2007167598, US 2005119421, US 4857623, EP 1245601, WO 2004/060953, and DE 2307794, the content of which is hereby adopted into the present specification.

The silylated polyethers which can be used in accordance with the invention are constructed from at least one polyether component and at least one silylating component. For some time, construction sealants have been on the market that comprise so-called MS-Polymer© from Kaneka and/or Excestar from Asahi Glass Chemical, where “MS” stands for “modified silicone”. These silyl-terminated polyethers are particularly suitable for the present invention. They are polymers which are composed of polyether chains with silane end groups, prepared by the hydrosilylation of terminal double bonds. The silane end groups are composed of a silicon which is attached to the polyether chain and to which two alkoxy groups and one alkyl group, or three alkoxy groups, are attached. As a result of the reaction with moisture, the alkoxy groups undergo hydrolysis to form alcohols, and the resultant Si—OH groups subsequently condense to form an Si—O—Si network. Suitable polyether components for the silyl-terminated polyethers include, among others, the polyols that are prepared, using starter molecules, from styrene oxide, propylene oxide, butylene oxide, tetrahydrofuran or epichlorohydrin. Especially suitable are polypropylene oxide, polybutylene oxide, polyethylene oxide and tetrahydrofuran or mixtures thereof. In this case, preference is given in particular to molecular weights between 500 and 100 000 g/mol, especially 3000 and 20 000 g/mol.

For the purpose of introducing the double bonds, the polyether is reacted with organic compounds comprising a halogen atom selected from the group consisting of chlorine, bromine and iodine, and with a terminal double bond. Particularly suitable for this purpose are allyl chlorides, allyl bromides, vinyl(chloromethyl)benzene, allyl(chloromethyl)benzene, allyl(bromomethyl)benzene, allyl chloromethyl ether, allyl(chloromethoxy)benzene, butenyl chloromethyl ether, 1,6-vinyl(chloromethoxy)benzene, with the use of allyl chloride being particularly preferred.

The resulting polyethers with terminal double bonds are reacted by hydrosilylation to form the silyl-terminated polyethers. Particularly suitable hydrosilylating agents for this reaction include trichlorosilane, methyldichlorosilane, dimethylchlorosilane, phenyldichlorosilane and also trimethoxysilane, triethoxysilane, methyldiethoxysilane, methyldimethoxysilane and phenyldimethoxysilane, and also methyldiacetoxysilane, phenyldiacetoxysilane, bis(dimethylketoximato)methylsilane and bis(cyclohexylketoximato)methylsilane. Particularly preferred in this context are the halosilanes and alkoxysilanes.

Reference is made, furthermore, to patent applications U.S. Pat. No. 3,971,751, EP 0319896, U.S. Pat. No. 4,618,653, EP 0184829, EP 0265929, EP 1285946, EP 0918062, Adhesives and Sealants—Technology, Applications and Markets, David J. Drunn, ISBN 1-85957-365-7, Rapra Technology Limited, 2003 and Congress proceedings 27 April 2005 Stick 4th European Congress on Adhesive and Sealant Raw Materials, Innovative Raw Materials for Structural Adhesives, ISBN 3-87870-156-X, Vincenz Network, 2005, the content of which is hereby adopted into the present specification.

The silylated polysulfides which can be used preferably in accordance with the invention are constructed from at least one polysulfide component and at least one silylating component, and are represented preferably by the following simplified formula:

(CH₃)₃—Si—S—(C₂H₄OCH₂OC₂H₄Sₓ)ₙ—C₂H₄OCH₂OC₂H₄S—Si—(CH₃)₃

These preferred silylated polysulfides are prepared by the following process:

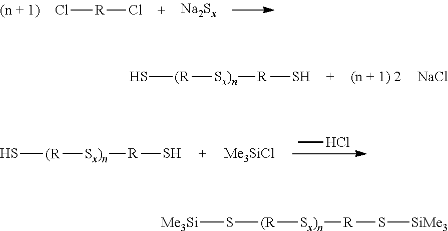

where R is represented by an alkyl group or an ether group.

With regard to the silylated polysulfides whose use is preferred in accordance with the present invention, reference is made to the publication “ALPIS Aliphatische Polysulfide”, Hüthig & Wepf, Basel, 1992, Heinz Lucke, ISBN 3-85739-1243, the content of which is hereby adopted into the present specification.

The silyl-terminated acrylates which can be used in accordance with the invention are constructed from at least one acrylate component and at least one silyl component. The silyl-terminated acrylates may be obtained, for example, from the reaction of alkenyl-terminated acrylates by hydrosilylation, the alkenyl-terminated acrylates being preparable by atom transfer radical polymerization (ATRP) or being preparable from the reaction of alkyl-terminated acrylates with a monomer comprising silyl groups, the alkenyl-terminated acrylates being preparable via atom transfer radical polymerization (ATRP).

The monomers of the acrylate component preferably comprise at least one compound from the series ethyldiglycol acrylate, 4-tert-butylcyclohexyl acrylate, dihydrocyclopentadienyl acrylate, lauryl(meth)acrylate, phenoxyethyl acrylate, isobornyl(meth)acrylate, dimethylaminoethyl methacrylate, cyanoacrylates, citraconate, itaconate and derivatives thereof, (meth)acrylic acid, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-pentyl(meth)acrylate, n-hexyl(meth)acrylate, cyclohexyl(meth)acrylate, n-heptyl(meth)acrylate, n-octyl(meth)acrylate, 2-ethylhexyl(meth)acrylate, nonyl(meth)acrylate, decyl(meth)acrylate, isodecyl(meth)acrylate, dodecyl(meth)acrylate, phenyl(meth)acrylate, tolyl(meth)acrylate, benzyl(meth)acrylate, 2-methoxyethyl(meth)acrylate, 3-methoxybutyl(meth)acrylate, 2-hydroxyethyl(meth)acrylate, 2-hydroxypropyl(meth)acrylate, stearyl(meth)acrylate, glycidyl(meth)acrylate, 2-aminoethyl(meth)acrylates, γ-(methacryloyloxypropyl)trimethoxysilane, ethylene oxide adducts of (meth)acrylic acid, trifluoromethylmethyl(meth)acrylate, 2-trifluoromethylethyl(meth)acrylate, 2-perfluoroethylethyl(meth)acrylate, 2-perfluoroethyl-2-perfluorobutylethyl(meth)acrylate, 2-perfluoroethyl(meth)acrylate, perfluoromethyl(meth)acrylate, diperfluoromethylmethyl(meth)acrylate, 2-perfluoromethyl-2-perfluoroethylmethyl(meth)acrylate, 2-perfluorohexylethyl(meth)acrylate, 2-perfluorodecylethyl(meth)acrylate and 2-perfluorohexadecylethyl(meth)acrylate.

Where the silyl component is attached by hydrosilylation to the acrylate component, suitable silyl components include more particularly trimethylchlorosilane, dimethyldichlorosilane, methyltrichlorosilane, hexamethyldisilazane, trichlorosilane, methyldichlorosilane, dimethylchlorosilane, phenyldichlorosilane and also trimethoxysilane, triethoxysilane, methyldiethoxysilane, methyldimethoxysilane and phenyldimethoxysilane, and also methyldiacetoxysilane, phenyldiacetoxysilane, bis(dimethylketoximat)methylsilane and bis(cyclohexylketoximat)methylsilane. Preferred in this case more particularly are the halosilanes and alkoxysilanes.

Where the silyl component is attached to the acrylate component by a monomer comprising silyl groups, suitable silyl components include more particularly 3-(meth)-acryloyloxypropyltrimethoxysilane, 3-(meth)acryloyloxypropylmethyldimethoxysilane, 3-(meth)acryloyloxypropyltriethoxysilane, 3-(meth)acryloyloxypropylmethyldiethoxysilane, (meth)acryloyloxymethyltrimethoxysilane, (meth)acryloyloxymethylmethyldimethoxysilane, (meth)acryloyloxymethyltriethoxysilane and (meth)acryloyloxymethylmethyldiethoxysilane.

The silyl-terminated acrylates of the invention possess a weight-average molecular weight of between 500 and 200 000 g/mol, more preferably between 5000 and 100 000 g/mol.

With regard to the silyl-terminated acrylates for preferred use in accordance with the present invention, reference is made to patent application EP 1498433 and to Chem. Rev. (2001), 101, 2921-2990, Atom Transfer Radical Polymerization, Krzysztof Matyjaszewski and Jianhui Xia, and to Progress in Polymer Science 32 (2007), 93-146, Controlled/living radical polymerization: Features, developments, and perspectives, Wade A. Braunecker, Krzysztof Matyjaszewski, Elsevier, the content of which is hereby adopted into the present specification.

Besides components (A) and (B), the composition of the invention may comprise additional, further components. These may be, among others, the following auxiliaries and additives:
Adhesion promoters, examples being epoxysilanes, anhydridosilanes, adducts of silanes with primary aminosilanes, ureidosilanes, aminosilanes, diaminosilanes, and also their analogs in the form of monomer or oligomer and urea-silanes; e.g. Dynasylan AMEO, Dynasylan AMMO, Dynasylan DAMO-T, Dynasylan 1146, Dynasylan 1189, Silquest A-Link 15,
water scavengers, e.g. vinyltriethoxysilane, vinyltrimethoxysilane, α-functional silanes such as N-(silylmethyl)-O-methyl-carbamates, more particularly N-(methyldimethoxysilylmethyl)-O-methyl-carbamate, (methacryloyloxymethyl)silanes, methoxymethylsilanes, N-phenyl-, N-cyclohexyl- and N-alkylsilanes, orthoformic esters, calcium oxide or molecular sieve;
catalysts, examples being metal catalysts in the form of organotin compounds such as dibutyltin dilaurate and dibutyltin diacetylacetonate, organobismuth compounds or bismuth complexes; compounds containing amino groups, examples being 1,4-diazabicyclo[2.2.2]octane and 2,2′-dimorpholinodiethyl ether, and also aminosilanes. Further suitable metal catalysts include titanium, zirconium, bismuth, zinc and lithium catalysts, and also metal carboxylates, it also being possible to use combinations of different metal catalysts and also combinations of aminosilanes and metal catalysts;
light stabilizers and aging inhibitors, which act in particular as stabilizers against heat, light and UV radiation;
flame retardants;
biocides, such as, for example, algicides, fungicides or fungal growth inhibitor substances;
fillers, e.g. ground or precipitated calcium carbonates, which optionally are coated with fatty acids or fatty acid mixtures, e.g. stearates, more particularly finely divided, coated calcium carbonate, carbon blacks, especially industrially manufactured carbon blacks, kaolins, aluminium oxides, silicas, more particularly highly disperse silica from pyrolysis processes, PVC powders or hollow beads. Preferred fillers are carbon black, calcium carbonates, such as precipitated or natural chalks such as Omyacarb® from Omya, Ultra P-Flex® from Specialty Minerals Inc, Socal® U1S2, Socal® 312, Winnofil® 312 from Solvay, Hakuenka® from Shiraishi, highly disperse silicas from pyrolysis processes, and combinations of these fillers. Likewise suitable are minerals such as siliceous earth, talc, calcium sulfate (gypsum) in the form of anhydrite, hemihydrate or dihydrate, finely ground quartz, silica gel, precipitated or natural barium sulfate, titanium dioxide, zeolites, leucite, potash feldspar, biotite, the group of soro-, cyclo-, ino-, phyllo- and hectosilicates, the group of low-solubility sulfates such as gypsum, anhydrite or heavy spar, and also calcium minerals such as calcite;
rheology modifiers, such as thickeners, e.g. urea compounds, polyamide waxes, bentonites, fumed silica and/or acrylates;
surface-active substances such as, for example, wetting agents, leveling agents, deaerating agents or defoamers, and dispersants;
fibers, as for example of polyethylene or polypropylene;
pigments, e.g. titanium dioxide;
solvents

and also further substances used in moisture-curing compositions.

In one embodiment the adhesive or sealant of the invention comprises 10 to 90% by weight of component (A), 3 to 50% by weight of component (B), 0 to 80% by weight of fillers, 0 to 20% by weight of water scavengers and 0.5 to 20% by weight of rheology modifiers. Considered as being preferred is an amount of 25 to 40% by weight of component (A), 5 to 40% by weight of component (B), 30 to 55% by weight of fillers, 1 to 10% by weight of water scavengers and 1 to 10% by weight of rheology modifiers.

A distinction is to be made between one component (1K) and two-component (2K) systems. 1K systems bind through chemical reactions of the binder with the ambient moisture. 2K systems are able additionally to set by chemical reactions of the mixed components, with continuous solidification. The adhesive and sealant of the invention is preferably a one-component system. However, it may also be advantageous to configure the system of the invention as a two-component system. In this case one component comprises the polymer component (A), while the second component comprises, for example, a catalyst or micronized water as a booster to accelerate the curing of the system. It is advantageous to ensure that the components employed in a one-component system do not adversely affect the shelflife of the composition, i.e. that they do not to a significant extent during storage initiate the reaction of the silane groups present in the composition that leads to crosslinking. More particularly this means that such further components comprise preferably no water or at most traces of water. It may therefore be sensible to carry out physical or chemical drying of certain components before incorporating and mixing them into these compositions. If such drying is not possible or not desirable, it may be advantageous in these cases to configure the adhesive or sealant as a two-component system, with the component or components which adversely affect the shelflife being formulated separately from component (A) into the second component.

The composition of the invention is stored in the absence of moisture, and is storage-stable, which means that, in the absence of moisture, it can be kept in a suitable pack or facility, such as a drum, a pouch or a cartridge, for example, over a period of several months to a number of years, without suffering any change that is relevant to its practical service in its performance properties or in its properties after curing. The storage stability or shelflife is typically determined via measurement of the viscosity, the extrusion quantity or the extrusion force.

The present invention additionally provides for the use of the adhesive or sealant for producing material bonds between parts that are to be joined. On application of the composition of the invention to at least one part to be joined, the silane group of the polymer comes into contact with moisture. A property of the silane groups is that of undergoing hydrolysis on contact with moisture. This process is accompanied by formation of organosilanols (organosilicon compound comprising one or more silanol groups, SiOH groups) and, by subsequent condensation reactions, organosiloxanes (organosilicon compound comprising one or more siloxane groups, Si—O—Si groups). As the outcome of this reaction, which can be accelerated through the use of catalysts, the composition finally cures. This process is also referred to as crosslinking. The water required for the curing reaction may come from the air (atmospheric humidity), or else the composition may be contacted with a water-comprising component, by being brushed with a smoothing agent, for example, or by being sprayed, or else a water-comprising component may be added to the composition at application, in the form, for example, of a water-containing paste which is mixed in, for example, via a static mixer.

The composition described cures, as already stated, on contact with moisture. Curing takes place at different rates depending on temperature, nature of contact, amount of moisture, and the presence of any catalysts. Curing by means of atmospheric moisture first forms a skin on the surface of the composition. The so-called skin formation time, accordingly, constitutes a measure of the cure rate. Typically it is desirable to aim for a skin formation time of up to 2 hours at 23° C. and 50% relative atmospheric humidity. In the cured state, the composition of the invention possesses a high mechanical strength in conjunction with high extensibility, and also has good adhesion properties. This makes it suitable for a multiplicity of applications, more particularly as an elastic adhesive, as an elastic sealant or as an elastic coating. It is especially suitable for applications which require rapid curing and which impose exacting requirements on extensibility at the same time as exacting requirements on the adhesion properties and the strengths.

Suitable applications are, for example, the material bonds between parts to be joined made of concrete, mortar, glass, metal, ceramic, plastic and/or wood. In one particular embodiment the parts to be joined are firstly a surface and secondly a covering in the form of carpet, PVC, laminate, rubber, cork, linoleum, wood, e.g. woodblock flooring, floorboards, boat decks or tiles. The composition of the invention can be used in particular for the manufacture or repair of industrial goods or consumer goods, and also for the sealing or bonding of components in construction or civil engineering, and also, in particular, in the sanitary sector. The parts to be joined may especially be parts in auto, trailer, lorry, caravan, train, aircraft, watercraft and railway construction.

An adhesive for elastic bonds in this sector is applied with preference in the form of a bead in a substantially round or triangular cross-sectional area. Elastic bonds in vehicle construction are, for example, the adhesive attachment of parts such as plastic covers, trim strips, flanges, bumpers, driver's cabs or other components for installation, to the painted body of a means of transport, or the bonding of glazing into the bodywork.

A preferred area of application in construction and civil engineering is that of construction joints, flooring joints, expansion joints or sealed joints in the sanitary sector. In one preferred embodiment the composition described is used as an elastic adhesive or sealant. In the form of an elastic adhesive, the composition typically has an elongation at break of at least 50%, and in the form of an elastic sealant it typically has an elongation at break of at least 300%, at room temperature.

For use of the composition as a sealant for joints, for example, in construction or civil engineering, or for use as an adhesive for elastic bonds in automotive construction, for example, the composition preferably has a paste-like consistency with properties of structural viscosity. A paste-like sealant or adhesive of this kind is applied by means of a suitable device to the part to be joined. Suitable methods of application are, for example, application from standard commercial cartridges which are operated manually or by means of compressed air, or from a drum or hobbock by means of a conveying pump or an eccentric screw pump, if desired by means of an application robot.

The parts to be joined may where necessary be pretreated before the adhesive or sealant is applied. Such pretreatments include, in particular, physical and/or chemical cleaning processes, examples being abrading, sandblasting, brushing or the like, or treatment with cleaners or solvents, or the application of an adhesion promoter, an adhesion promoter solution or a primer.

In the context of its use as an adhesive, the composition of the invention is applied either to one or the other part to be joined, or to both parts to be joined. Thereafter the parts to be bonded are joined, and the adhesive cures through contact with moisture. It must in each case be ensured that the joining of the parts takes place within what is referred to as the open time, in order to ensure that the two parts to be joined are reliably bonded to one another.

The present invention further provides a process for preparing an adhesive or sealant, where a) component (B) and optionally at least one compound from the group consisting of filler, thixotropic agent, antioxidant and UV absorber is introduced, b) the mixture is optionally dried at a temperature of more than 60° C. under reduced pressure to <5000 ppm of water, c) optionally at least one compound from the series consisting of water scavengers and adhesion promoters, and d) component (A), is added, the components being mixed homogeneously.

In one preferred embodiment, the components introduced under a) are dried under reduced pressure at a temperature of more than 100° C., more preferably more than 130° C. A reduced pressure of below 100 mmHg, more particularly below 10 mmHg, is considered to be preferred in particular. The water content after drying ought to be as low as possible; preferably, it ought to be below 2000 ppm, more particularly below 800 ppm. The water content is determined by the Karl Fischer method.

For the preparation process of the invention it is considered preferred that the components employed are mixed with one another and/or kept moving throughout the entire operation, including drying where practiced. Alternatively the components employed may also be mixed homogeneously with one another only at the end of the preparation process. Suitable mixing equipment encompasses all of the apparatus known for this purpose to the skilled person, and more particularly may be a static mixer, planetary mixer, horizontal turbulent mixer (from Drais), planetary dissolver or dissolver (from PC Laborsysteme), intensive mixer and/or extruder.

The process of the invention for preparing the adhesive or sealant may be carried out discontinuously in, for example, a planetary mixer. It is, however, also possible to operate the process continuously, in which case extruders in particular have been found suitable for this purpose. In that case the binder is fed to the extruder, and liquid and solid adjuvants are metered in.

All in all, with the proposed adhesives and sealants comprising cyclohexanepolycarboxylic acid derivatives, compositions are provided which are notable for enhanced extensibility in conjunction with high reactivity and good adhesion properties. Cyclohexanepolycarboxylic acid derivatives are available cost-effectively on an industrial scale. Through the provision of the adhesives and sealants of the invention, therefore, it has been possible to achieve the stated object in its entirety.

The invention is illustrated in more detail with reference to the nonlimiting examples below.

### EXAMPLES

General Preparation Procedure

Plasticizer, Socal U1S2, Omyalite 90 T, Tronox 435 and Dynasylan VTMO are introduced and mixed with one another under reduced pressure at a temperature of 60° C. Subsequently, binder and Aerosil R 202 are added. In the last step, Dynasylan AMMO and Metatin 740 are added and mixed. The sealant is dispensed into aluminum or plastic cartridges.

### Example 1

| | | Hexamoll ® | % by |
|---|---|---|---|
| | DIUP | DINCH | weight |
| Plasticizer | 120.00 | 120.00 | 15.00 |
| Socal U1S2 | 308.40 | 308.40 | 41.45 |
| Binder | 240.00 | 240.00 | 30.00 |
| Aerosil R 202 | 16.00 | 16.00 | 2.00 |
| Tronox 435 | 32.00 | 32.00 | 4.00 |
| Omyalite 90 T | 40.00 | 40.00 | 5.00 |
| Dynasylan VTMO | 16.00 | 16.00 | 2.00 |
| Dynasylan AMMO | 4.00 | 4.00 | 0.50 |
| Metatin 740 | 0.40 | 0.40 | 0.05 |
| Total | 800.00 | 800.00 | 100.00 |

The numerical figures in columns two and three relate to parts by weight.

### Example 2

| | | Hexamoll ® | |
|---|---|---|---|
| | DIUP | DINCH | % |
| Plasticizer | 180.00 | 180.00 | 22.50 |
| Socal U1S2 (dried) | 308.40 | 308.40 | 42.45 |
| Binder | 180.00 | 180.00 | 22.50 |
| Aerosil R 202 | 16.00 | 16.00 | 2.00 |
| Tronox 435 (dried) | 32.00 | 32.00 | 4.00 |
| Omyalite 90 T (dried) | 40.00 | 40.00 | 5.00 |
| Dynasylan VTMO | 16.00 | 16.00 | 2.00 |
| Dynasylan AMMO | 4.00 | 4.00 | 0.50 |
| Metatin 740 | 0.40 | 0.40 | 0.05 |
| Total | 800.00 | 800.00 | 100.00 |

The numerical figures in columns two and three relate to parts by weight. dried: <5000 ppm water
DIUP: Diisoundecyl phthalate
Hexamoll® DINCH: Diisononyl cyclohexane-1,2-dicarboxylate from BASF SE
Example 1 binder: Desmoseal® S XP 2636 (silane-terminated polyurethane prepolymer) from Bayer MaterialScience AG
Example 2 binder: Geniosil® STP-E35 (trimethoxysilylpropylcarbamate-terminated polyether, CAS No.: 216597-12-5) from Wacker Chemie AG
Socal U1S2: Precipitated chalk, ultrafine, coated, from Solvay S.A.
Tronox 435: Titanium dioxide from Tronox Pigments GmbH
Omyalite 90 T: High-purity, surface-treated calcium carbonate from Omya Inc.
Dynasylan VTMO: Vinyltrimethoxysilane from Evonik Degussa GmbH
Dynasylan AMMO: 3-Aminopropyltrimethoxysilane from Evonik Degussa GmbH
Metatin 740: Dibutyltin ketonate from Acima AG

Results

### Example 1

| | | Hexamoll ® |
|---|---|---|
| | DIUP | DINCH |
| Tensile strength after 7 days' | | |
| storage at 20° C.: | | |
| Elongation % | 360.87 | 420.82 |
| Tensile strength N/mm² | 2.19 | 1.99 |
| 100% force N/mm² | 1.00 | 0.85 |
| Skin formation time in minutes: | 59.19 | 55.11 |
| Tack at 23° C. and 50% humidity: | | |
| after 1 day | 2 | 2 |
| after 3 days | 1-2 | 1-2 |
| after 7 days | 1 | 1 |
| Shore A hardness after 14 days' | 36.0 | 38.3 |
| storage at 20° C.: | | |
| Skin formation time in minutes; | | |
| 30 cm per hour: | | |
| zero point | 0 | 0 |
| 1st measuring point | 13.5 cm = 27 min | 16 cm = 32 min |
| 2nd measuring point | 31 cm = 62 min | 35 cm = 70 min |
| remaining time to start in min. | 6.13 | 3.33 |

### Example 2

| | | Hexamoll ® |
|---|---|---|
| | DIUP | DINCH |
| Tensile strength after 7 days' | | |
| storage at 20° C.: | | |
| Elongation % | 315.37 | 369.69 |
| Tensile strength N/mm² | 1.89 | 1.34 |
| 100% force N/mm² | 0.82 | 0.59 |
| Skin formation time in minutes: | 57.38 | 106.32 |
| Tack at 23° C. and 50% humidity: | | |
| after 1 day | — | 1 |
| after 3 days | 3 | 1 |
| after 7 days | 1-2 | 1 |
| Shore A hardness after 14 days' | 36.0 | 38.3 |
| storage at 20° C.: | | |
| Skin formation time in minutes; | | |
| stage 5; 30 cm per hour: | | |
| zero point | 0 | 0 |
| 1st measuring point | 13.5 cm = 27 min | 16 cm = 32 min |
| 2nd measuring point | 31 cm = 62 min | 35 cm = 70 min |
| remaining time to start in min | 6.13 | 3.33 |

As is apparent from the examples, it is possible through the addition of Hexamoll® DINCH to increase the elongation, as compared with the use of conventional phthalates such as DIUP, for example, in the adhesive and sealant.

1.-15. (canceled)

16. An adhesive or sealant comprising:
(A) at least one compound selected from the group consisting of silylated polyurethanes, silylated polyureas, silylated polyethers, silylated polysulfides and silyl-terminated acrylates, and
(B) at least one cyclohexane-1,2-dicarboxylic acid di(isononyl) ester.

17. The adhesive or sealant according to claim 16, comprising:
10 to 90% of component (A)
3 to 50% of component (B)
0 to 80% of fillers
0 to 20% of water scavengers,
0 to 10% of rheology modifiers.

18. The adhesive or sealant according to claim 16, further comprising, auxiliaries and additives, dispersants, pigments, rheological assistants, water scavengers, adhesion promoters, catalysts, light stabilizers, aging inhibitors, flame retardants and/or biocides.

19. The adhesive or sealant according to claim 16, which is a one-component system.

20. The adhesive or sealant according to claim 16, which is a two-component system.

21. A process for preparing an adhesive or sealant according to claim 16, wherein
a) component (B) and optionally at least one compound from the series consisting of filler, thixotropic agent, antioxidant and UV absorber is introduced,
b) the mixture is dried optionally at a temperature of more than 60° C. under reduced pressure to <5000 ppm of water,
c) optionally at least one compound from the series consisting of water scavengers and adhesion promoters, and
d) component (A) is added,
the components being mixed homogeneously.

22. The process for preparing an adhesive or sealant according to claim 21, wherein the process is carried out discontinuously.

23. The process for preparing an adhesive or sealant according to claim 21, wherein the process is carried out continuously.

24. A method of joining parts with a material bond comprising utilizing the adhesive or sealant according to claim 16.

25. The method of claim 24, wherein the parts to be joined are made of concrete, mortar, glass, metal, ceramic, plastic and/or wood.

26. The method of claim 24, wherein one of the parts to be joined is a surface and the other is a carpet covering, a PVC covering, a laminate, a rubber covering, a cork covering, a linoleum covering, a wood covering or tiles.

27. The method of claim 24, wherein the material bond is a construction joint, an expansion joint, a flooring joint, a facade joint, building partition joints, flashing joints, glazing, window glazing, structural glazing, roof glazing, window sealing or a sealed joint in the sanitary sector.

28. The method of claim 24, wherein the parts to be joined are parts in auto, lorry, caravan, train, trailer, aircraft, watercraft and railway construction.
